(19) United States
(12) Patent Application Publication
(10) Pub. No.: US 2010/0085398 A1
(43) Pub. Date: Apr. 8, 2010

(54) INK SURFACE DETECTING SYSTEMS AND INK CARTRIDGE

(75) Inventor: Hirotake NAKAMURA, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/563,981

(22) Filed: Sep. 21, 2009

(30) Foreign Application Priority Data
Oct. 7, 2008 (JP) 2008-260439

(51) Int. Cl. B41J 29/393

(52) U.S. Cl. 347/19

(57) ABSTRACT

An ink surface detecting system has an ink cartridge and a first optical detector, and a second optical detector positioned above the first optical detector. The ink cartridge has an ink chamber and a pivoting member having a detected portion and a floating portion. A first distance between the center of pivotal movement of the pivoting member and a first end of the pivoting member is different from a second distance between the center of pivotal movement and a second end of the pivoting member.

### CROSS-REFERENCE TO RELATED APPLICATION

The present application claims priority from Japanese Patent Application No. JP-2008-260439, which was filed on Oct. 7, 2008, the disclosure of which is incorporated herein by reference in its entirety.

### BACKGROUND OF THE INVENTION

1. Field of the Invention

The present invention relates to an ink surface detecting system configured to conduct multistep detection of the position of ink surface in an ink chamber of an ink tank such as an ink cartridge, and to such an ink cartridge.

2. Description of Related Art

A known ink jet printer has a printhead, and ink is supplied from an ink tank to the printhead as ink is discharged from the printhead. The ink tank may be fixed to the ink-jet printer in some cases, or may be an ink cartridge configured to be removably mounted to the ink-jet printer in some cases. The ink jet printer can detect the amount of ink stored in the ink tank.

An ink jet printer described in JP-A-8-132642 has a printhead and an ink tank which is in fluid communication with the printhead. A float is positioned in the ink tank, and the float moves up and down in the ink tank in association with upward and downward movement of the surface of ink stored in the ink tank. The ink-jet printer has an ink amount detector, and the ink amount detector has a pair of first light-emitting element and first light-receiving element, and a pair of second light-emitting element and second light-receiving element. The first light-emitting element and the first light-receiving element are aligned in a horizontal direction, sandwiching the ink tank. The second light-emitting element and the second light-receiving element are aligned in the horizontal direction, sandwiching the ink tank, below the first light-emitting element and the first light-receiving element. The first light-emitting element emits light toward the interior of the ink tank. When the first light-emitting element and the float are aligned in the horizontal direction, the light emitted from the first light-emitting element is blocked by the float, and the first light-receiving element does not receive the light. When the first light-emitting element and the float are not aligned in the horizontal direction, the light emitted from the first light-emitting element is not blocked, and the first light-receiving element receives the light which has passed through the ink tank. Similarly, when the second light-emitting element and the float are aligned in the horizontal direction, the light emitted from the second light-emitting element is blocked by the float, and the second light-receiving element does not receive the light. When the second light-emitting element and the float are not aligned in the horizontal direction, the light emitted from the second light-emitting element is not blocked, and the second light-receiving element receives the light which has passed through the ink tank. Accordingly, the ink amount detector detects the position of the ink surface in two steps, i.e., detects two different positions of the ink surface.

The positions of the pair of first light-emitting element and first light-receiving element and the pair of second light-emitting element and second light-receiving element in the vertical direction inevitably depend on the positions of the ink surface which the ink amount detector is made to detect. In other words, the distance between the pair of first light-emitting element and first light-receiving element and the pair of second light-emitting element and second light-receiving element in the vertical direction is substantially equal to the distance between the two positions of the ink surface which the ink amount detector is made to detect. For example, when the ink amount detector is made to detect two positions of the ink surface which are apart from each other to a relatively large extent, the distance between the pair of first light-emitting element and first light-receiving element and the pair of second light-emitting element and second light-receiving element should be increased according to the distance between the two positions of the ink surface. Nevertheless, depending on the structure of the ink jet printer, there might not be a sufficient space for positioning the pair of first light-emitting element and first light-receiving element and the pair of second light-emitting element and second light-receiving element which are apart from each other to a large extent. In contrast, when the ink amount detector is made to detect two positions of the ink surface which are apart from each other to a relatively small extent, the distance between the pair of first light-emitting element and first light-receiving element and the pair of second light-emitting element and second light-receiving element should be decreased according to the distance between the two positions of the ink surface. Nevertheless, depending on the structure of the pair of first light-emitting element and first light-receiving element and the pair of second light-emitting element and second light-receiving element, the pair of first light-emitting element and first light-receiving element and the pair of second light-emitting element and second light-receiving element might not be able to be positioned sufficiently close to each other. As such, the positions of the pair of first light-emitting element and first light-receiving element and the pair of second light-emitting element and second light-receiving element in the vertical direction depends on the positions of the ink surface which the ink amount detector means is made to detect, which reduces flexibility in design of the ink-jet printer.

### SUMMARY OF THE INVENTION

Therefore, a need has arisen for an ink surface detecting system and an ink cartridge which at least reduce these and other shortcomings of the related art. A technical advantage of the present invention is that positions of ink surface in an ink chamber are detected in multiple steps while flexibility in positioning optical detectors is secured.

According to an embodiment of the present invention, an ink surface detecting system comprises an ink cartridge comprising an ink chamber configured to store ink therein and a pivoting member positioned in the ink chamber and configured to pivot in the ink chamber according to a position of a surface of the ink stored in the ink chamber. The pivoting member comprises a detected portion and a floating portion having a specific gravity less than a specific gravity of the ink stored in the ink chamber. The ink surface detecting system further comprises a mounting portion to which the ink cartridge is configured to be removably mounted. The ink surface detecting system further comprises a first optical detector positioned at the mounting portion, which comprises a first light-emitting portion configured to emit light in a direction intersecting a path along which the detected portion moves with respect to the ink chamber when the ink cartridge is mounted to the mounting portion and a first light-receiving portion configured to selectively assume two states according to a position of the detected portion in the path. The ink surface detecting system further comprises a second optical detector positioned at the mounting portion above the first optical detector, which comprises a second light-emitting portion configured to emit light in the direction intersecting the path when the ink cartridge is mounted to the mounting portion and a second light-receiving portion configured to selectively assume two states according to the position of the detected portion in the path. The pivoting member is configured to pivot with respect to the ink chamber in a first plane. The floating portion and the detected portion are positioned such that a second plane is positioned between the floating portion and the detected portion when the ink cartridge is mounted to the mounting portion, the second plane being perpendicular to the first plane, intersecting a center of a pivotal movement of the pivoting member, and being parallel to the direction of gravity. The floating portion comprises a first end positioned farthest from the center of the pivotal movement in the floating portion. The detected portion comprises a second end positioned farthest from the center of the pivotal movement in the detected portion. A first distance between the center of pivotal movement and the first end is different from a second distance between the center of pivotal movement and the second end.

According to another embodiment of the present invention, an ink surface detecting system comprises an ink tank comprising an ink chamber configured to store ink therein and a pivoting member positioned in the ink chamber and configured to pivot in the ink chamber according to a position of a surface of the ink stored in the ink chamber. The pivoting member comprises a detected portion and a floating portion having a specific gravity less than a specific gravity of the ink stored in the ink chamber. The ink surface detecting system further comprises a first optical detector comprising a first light-emitting portion configured to emit light in a direction intersecting a path along which the detected portion moves with respect to the ink chamber and a first light-receiving portion configured to selectively assume two states according to a position of the detected portion in the path. The ink surface detecting system further comprises a second optical detector positioned above the first optical detector, which comprises a second light-emitting portion configured to emit light in the direction intersecting the path and a second light-receiving portion configured to selectively assume two states according to the position of the detected portion in the path. The pivoting member is configured to pivot with respect to the ink chamber in a first plane. The floating portion and the detected portion are positioned such that a second plane is positioned between the floating portion and the detected portion when the ink cartridge is mounted to the mounting portion, the second plane being perpendicular to the first plane, intersecting a center of a pivotal movement of the pivoting member, and being parallel to the direction of gravity. The floating portion comprises a first end positioned farthest from the center of the pivotal movement in the floating portion. The detected portion comprises a second end positioned farthest from the center of the pivotal movement in the detected portion. A first distance between the center of pivotal movement and the first end is different from a second distance between the center of pivotal movement and the second end.

According to yet another embodiment of the present invention, an ink cartridge comprising an ink chamber configured to store ink therein and a pivoting member positioned in the ink chamber and configured to pivot in the ink chamber according to a position of a surface of the ink stored in the ink chamber. The pivoting member comprises a detected portion and a floating portion having a specific gravity less than a specific gravity of the ink stored in the ink chamber. The pivoting member is configured to pivot with respect to the ink chamber in a first plane. The floating portion and the detected portion are positioned such that a second plane is positioned between the floating portion and the detected portion. The second plane is perpendicular to the first plane, intersecting a center of a pivotal movement of the pivoting member. The floating portion comprises a first end positioned farthest from the center of the pivotal movement in the floating portion. The detected portion comprises a second end positioned farthest from the center of the pivotal movement in the detected portion. A first distance between the center of pivotal movement and the first end is greater than a second distance between the center of pivotal movement and the second end.

Other objects, features, and advantages of embodiments of the present invention will be apparent to persons of ordinary skill in the art from the following description of preferred embodiments with reference to the accompanying drawings.

### BRIEF DESCRIPTION OF DRAWINGS

For a more complete understanding of the present invention, the needs satisfied thereby, and the objects, features, and advantages thereof, reference now is made to the following description taken in connection with the accompanying drawings.

FIG. 1 is a schematic view of an ink discharging system according to a first embodiment of the present invention.

FIG. 2(A) is a front view of an ink cartridge.

FIG. 2(B) is a side view of the ink cartridge of FIG. 2(A).

FIG. 3 is a side view of a frame of the ink cartridge of FIG. 2(A) in which a pair of side walls is removed.

FIG. 4(A) is a cross-sectional view of the ink cartridge taken along the line IVA-IVA shown in FIG. 2(B).

FIG. 4(B) is a cross-sectional view of the ink cartridge taken along the line IVB-IVB shown in FIG. 2(A).

FIG. 5(A) is a cross-sectional view of the ink cartridge corresponding to FIG. 4(A) in which a pivoting member is removed.

FIG. 5 (B) is a cross-sectional view of the ink cartridge corresponding to FIG. 4 (B) in which the pivoting member is removed.

FIG. 6 is a perspective view of the pivoting member.

FIG. 7 is a front view of an ink supply device.

FIG. 8 is a side view of the ink supply device.

FIG. 9 is a cross-sectional view of a mounting portion taken along the line IX-IX shown in FIG. 7.

FIG. 10 is a perspective view of a first optical sensor and a second optical sensor.

FIG. 11 is a cross-sectional view of the ink cartridge and the mounting portion taken along the line IX-IX shown in FIG. 7, in which the ink cartridge is mounted to the mounting portion.

FIG. 12 is a block diagram of an electrical configuration of an ink-jet printer.

FIG. 13 is a cross-sectional view of the ink cartridge and the mounting portion similarly to those shown in FIG. 11 when an ink surface in an ink chamber is at a first ink surface position.

FIG. 14 is a cross-sectional view of the ink cartridge and the mounting portion similarly to those shown in FIG. 11 when the ink surface in the ink chamber is at a second ink surface position.

FIG. 15 is a cross-sectional view of the ink cartridge and the mounting portion similarly to those shown in FIG. 11 when the ink surface in the ink chamber is at a third ink surface position.

FIG. 16 is a cross-sectional view of the ink cartridge and the mounting portion similarly to those shown in FIG. 11 when the ink surface in the ink chamber is at a fourth ink surface position.

FIG. 17 is a flowchart showing steps of a procedure for determining a remaining amount of ink in the ink chamber of the ink cartridge performed by a control unit. “LRP” means “light-receiving portion.”

FIG. 18 is a flowchart showing steps of the procedure for determining the remaining amount of ink in the ink chamber of the ink cartridge performed by the control unit. “LRP” means “light-receiving portion.”

FIG. 19 is a flowchart showing steps of the procedure for determining the remaining amount of ink in the ink chamber of the ink cartridge performed by the control unit. “LRP” means “light-receiving portion.”

FIG. 20 is a flowchart showing steps of the procedure for determining the remaining amount of ink in the ink chamber of the ink cartridge performed by the control unit.

FIGS. 21(A)-21(E) are schematic views of a remaining amount display portion of a display portion.

FIG. 22 shows the pivoting member and the ink surface L extracted from FIG. 13 and FIG. 16 and superimposed one on top of another.

FIG. 23 shows the pivoting member and the ink surface extracted from FIG. 13 and FIG. 15 and superimposed one on top of another.

FIG. 24 shows the pivoting member and the ink surface extracted from FIG. 13 and FIG. 14 and superimposed one on top of another.

FIG. 25 shows the pivoting member and the ink surface extracted from FIG. 14 and FIG. 16 and superimposed one on top of another.

FIG. 26 shows the pivoting member and the ink surface extracted from FIG. 14 and FIG. 15 and superimposed one on top of another.

FIG. 27 shows the pivoting member and the ink surface extracted from FIG. 15 and FIG. 16 and superimposed one on top of another.

FIG. 28 is a cross-sectional view of the ink cartridge and the mounting portion according to a second embodiment of the present invention, in which the ink cartridge is mounted to the mounting portion similarly to those shown in FIG. 11.

FIG. 29 is a cross-sectional view of the ink cartridge and the mounting portion similarly to those shown in FIG. 28 when the ink surface in the ink chamber is at a fifth ink surface position.

FIG. 30 is a cross-sectional view of the ink cartridge and the mounting portion similarly to those shown in FIG. 28 when the ink surface in the ink chamber is at a sixth ink surface position.

FIG. 31 is a cross-sectional view of the ink cartridge and the mounting portion similarly to those shown in FIG. 28 when the ink surface in the ink chamber is at a seventh ink surface position.

FIG. 32 is a flowchart showing steps of the procedure for determining the remaining amount of ink in the ink chamber of the ink cartridge performed by the control unit according to the second embodiment of the present invention. “LRP” means “light-receiving portion.”

FIG. 33 is a flowchart showing steps of the procedure for determining the remaining amount of ink in the ink chamber of the ink cartridge performed by the control unit according to the second embodiment of the present invention. “LRP” means “light-receiving portion.”

FIG. 34 is a flowchart showing steps of the procedure for determining the remaining amount of ink in the ink chamber of the ink cartridge performed by the control unit according to the second embodiment of the present invention.

FIGS. 35(A)-35(D) are schematic views of the remaining amount display portion of the display portion according to the second embodiment of the present invention.

FIG. 36 shows the pivoting member and the ink surface extracted from FIG. 29 and FIG. 31 and superimposed one on top of another.

FIG. 37 shows the pivoting member and the ink surface extracted from FIG. 29 and FIG. 30 and superimposed one on top of another.

FIG. 38 shows the pivoting member and the ink surface extracted from FIG. 30 and FIG. 31 and superimposed one on top of another.

FIG. 39 is a cross-sectional view of the ink cartridge and the mounting portion according to a third embodiment of the present invention, in which the ink cartridge is mounted to the mounting portion similarly to those shown in FIG. 11. The ink surface in the ink chamber is at an eighth ink surface position.

FIG. 40 is a cross-sectional view of the ink cartridge and the mounting portion similarly to those shown in FIG. 39 when the ink surface in the ink chamber is at a ninth ink surface position.

FIG. 41 is a cross-sectional view of the ink cartridge and the mounting portion similarly to those shown in FIG. 39 when the ink surface in the ink chamber is at a tenth ink surface position.

### DETAILED DESCRIPTION OF EMBODIMENTS

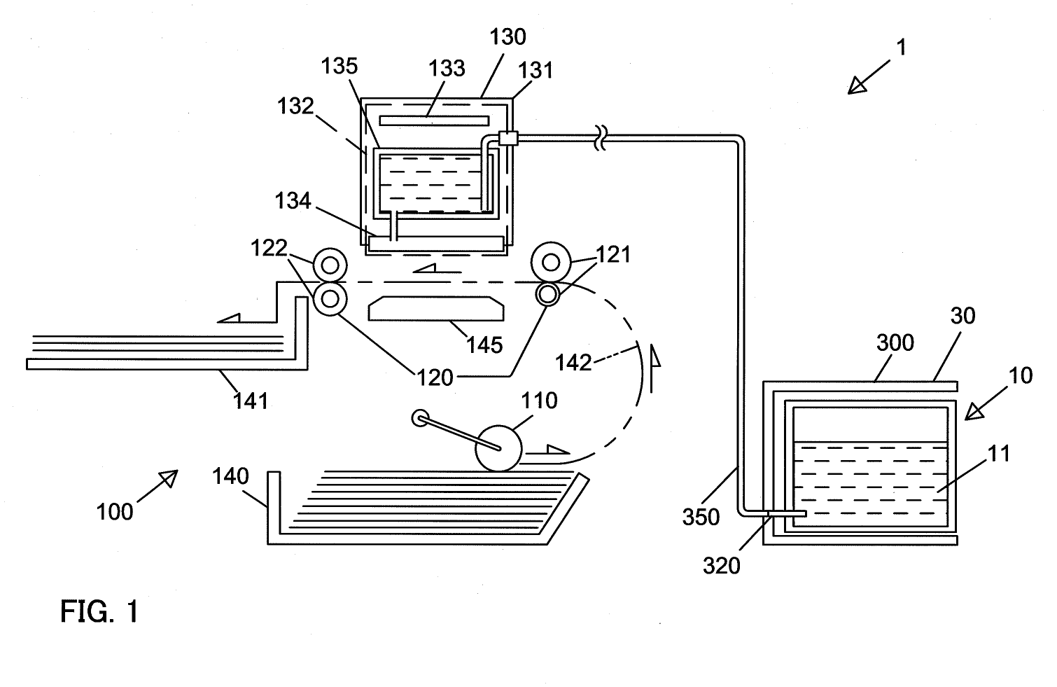

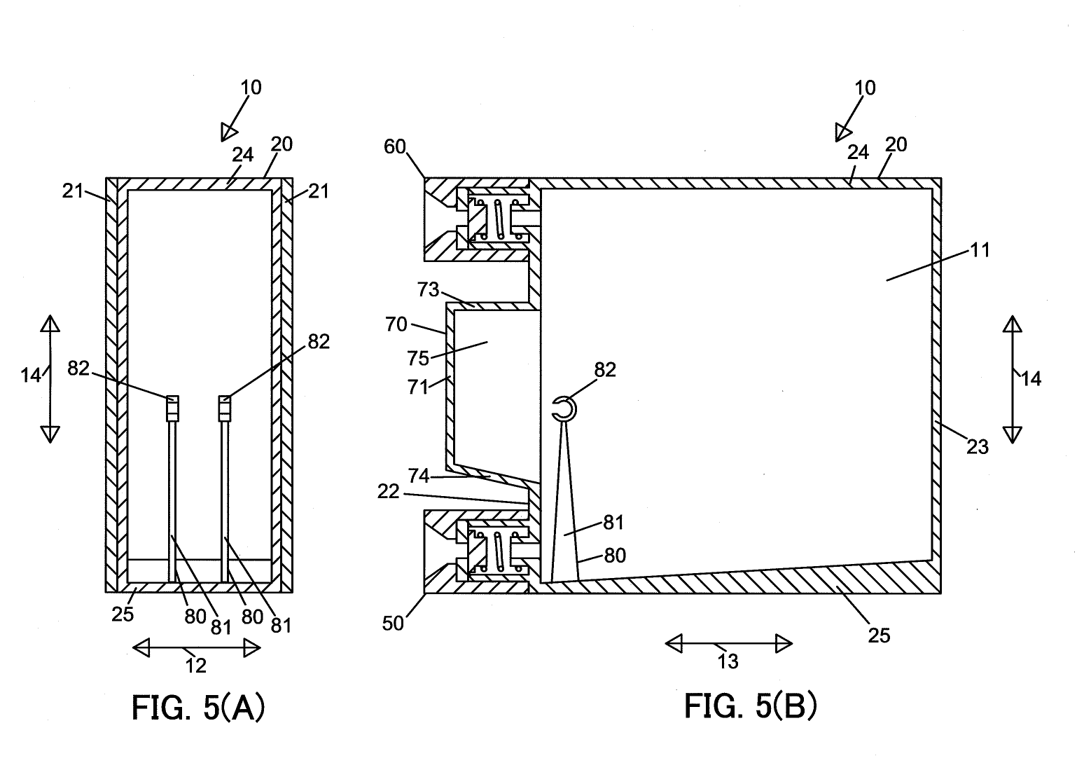

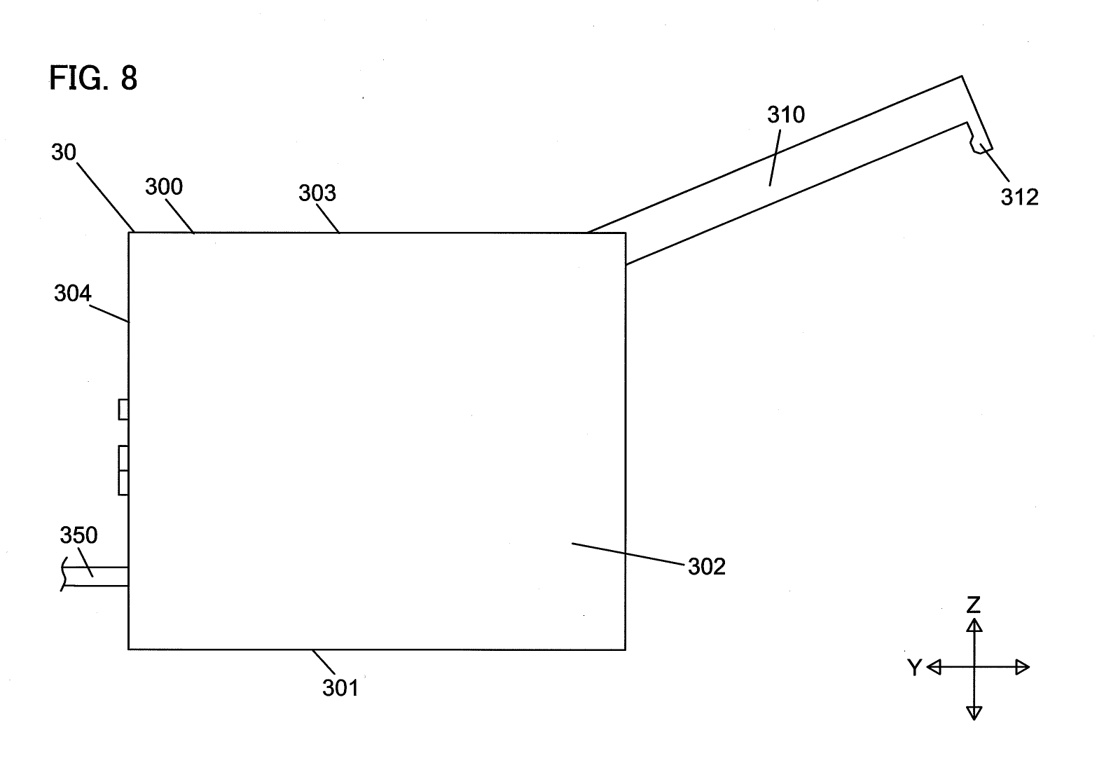

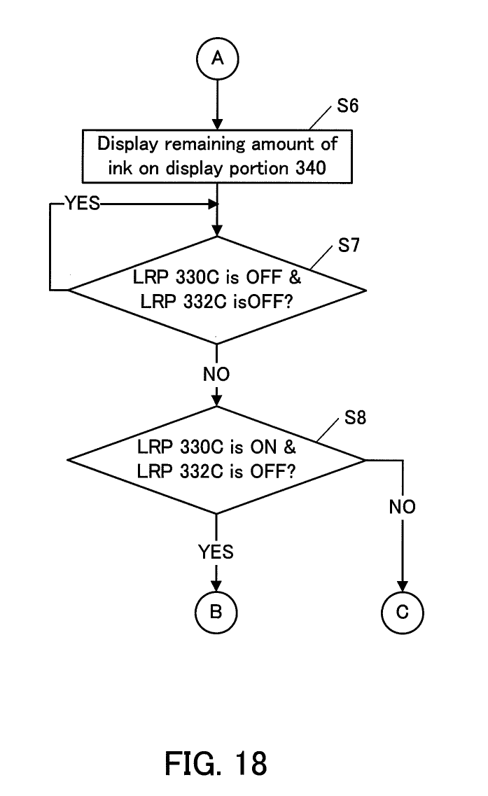

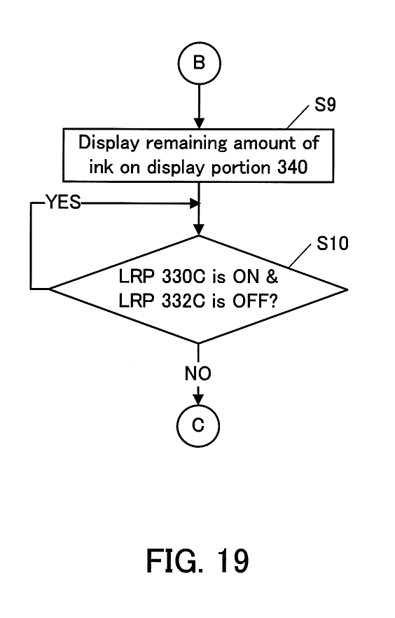

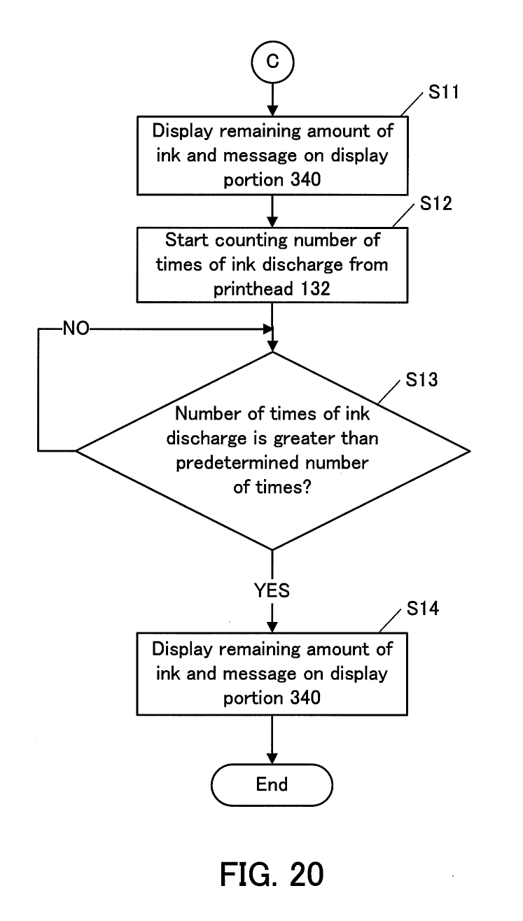

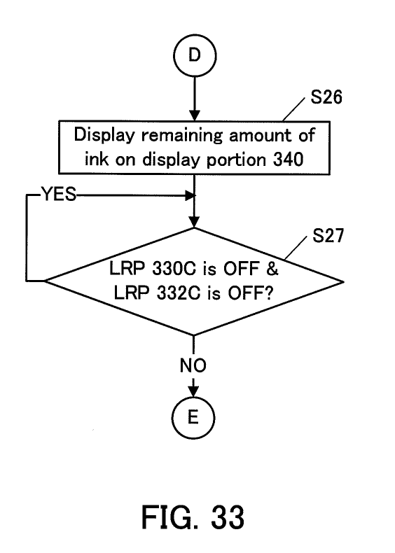

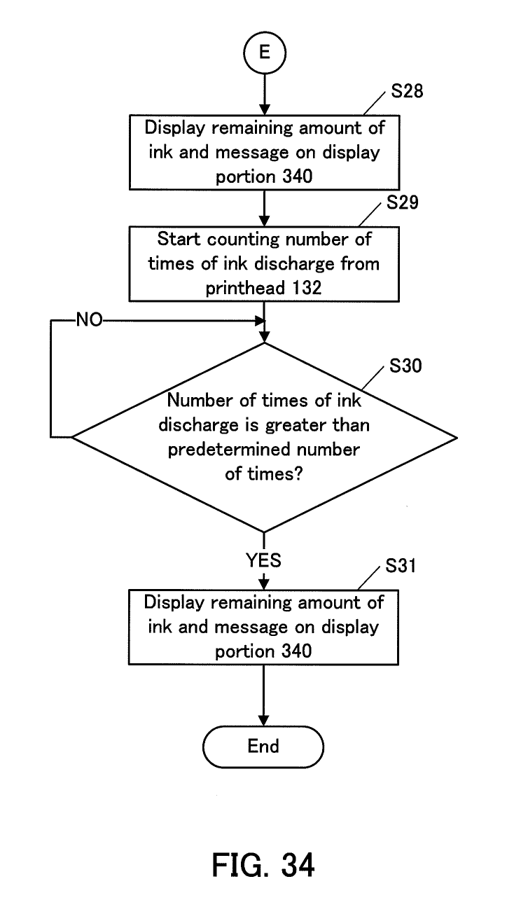

Embodiments of the present invention and their features and technical advantages may be understood by referring to FIGS. 1-41, like numerals being used for like corresponding portions in the various drawings.

Referring now to FIG. 1 to FIG. 27, an ink discharging system according to a first embodiment of the present invention is described.

<General Configuration> Referring to FIG. 1, an ink discharging system 1 as an example of the ink surface detecting system of the present invention comprises an ink-jet printer 100, and at least one ink cartridge 10 as an example of an ink tank and an ink cartridge of the present invention. The ink jet printer 100 is configured to print an image on a recording medium, for example, on a sheet of printing paper using ink in at least one color, for example, ink in four colors such as black ink, yellow ink, cyan ink, and magenta ink. The ink jet printer 100 comprises a paper feeding device 110, a transporting device 120, and a printing device 130. The ink jet printer 100 also comprises a first tray 140 and a second tray 141. A transporting path 142 is formed so as to extend from the first tray 140 to the second tray 141. The paper feeding device 110 is configured to feed a plurality of sheets of printing paper stored in the first tray 140 one by one to the transporting path 142.

The transporting device 120 comprises a first transporting roller pair 121 and a second transporting roller pair 122. The first transporting roller pair 121 and the second transporting roller pair 122 are positioned along the transporting path 142 and the first transporting roller pair 121 is positioned on the upstream side of the printing device 130 in terms of the direction in which the sheet of printing paper is transported, and the second transporting roller pair 122 is positioned on the downstream side of the printing device 130.

The ink-jet printer 100 comprises a platen 145. The platen 145 is positioned right below the printing device 130. The sheet of printing paper fed by the paper feeding device 110 is transported by the first transporting roller pair 121 onto the platen 145. The printing device 130 records an image on the sheet of printing paper transported on the platen 145. The printing paper which has passed over the platen 145 is transported by the second transporting roller pair 122 so as to be stored in the second tray 141 positioned at the end of the transporting path 142.

The printing device 130 comprises a carriage 131, a printhead 132 positioned on the carriage 131, and a head control board 133. A plurality of nozzles 134 are formed in the printhead 132. The printhead 132 comprises at least one sub tank 135, e.g., four sub tanks 135. The carriage 131 is supported by a plurality of rails (not shown) and is configured to reciprocate while sliding on the rails in the direction perpendicular to the paper surface of FIG. 1. The sub tanks 135 are respectively configured to store ink supplied to the nozzles 134. For example, the respective sub tanks 135 store ink in colors different from each other. When a signal is inputted to the head control board 133, the head control board 133 controls the printhead 132 on the basis of the inputted signal, and causes the ink to be discharged from the nozzles 134.

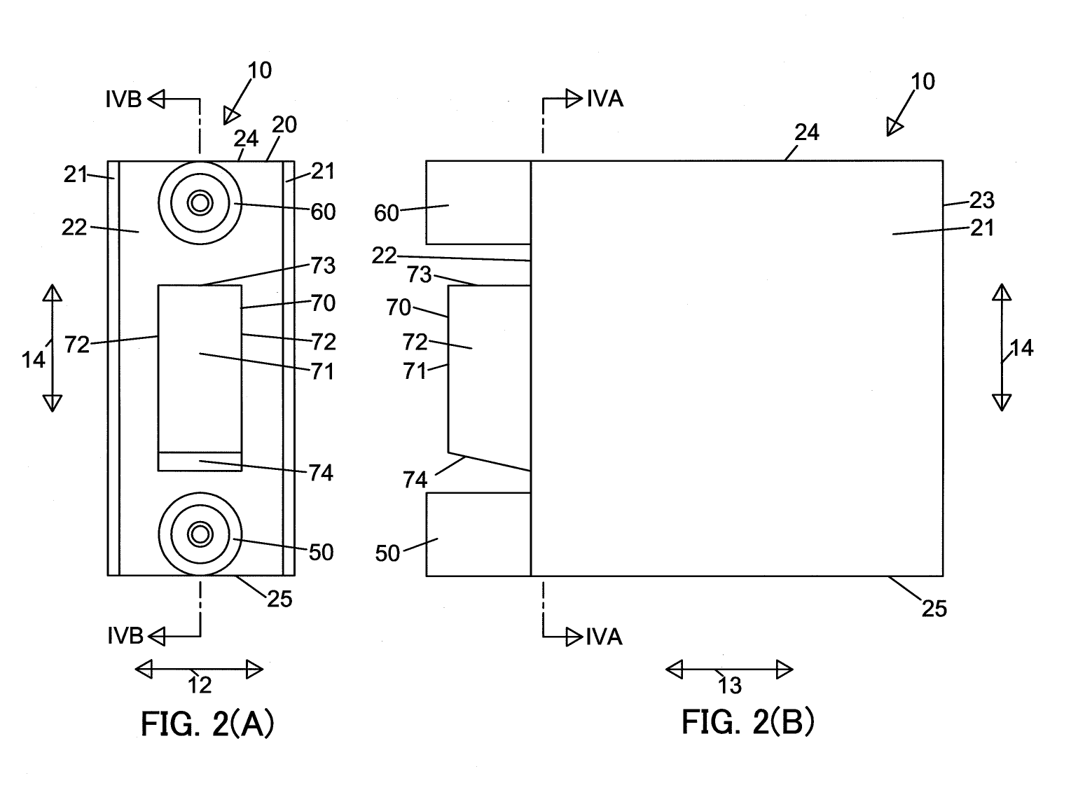

The ink-jet printer 100 comprises an ink supply device 30. The ink supply device 30 comprises at least one mounting portion 300. The ink cartridge 10 is configured to be removably mounted to the mounting portion 300. For example, the four ink cartridges 10 in which black ink, yellow ink, cyan ink, and magenta ink are stored respectively are removably mounted to the four mounting portions 300 respectively. The ink supply device 30 comprises at least one flexible tube 350. For example the ink supply device 30 comprises the four tubes 350, and one end of the tube 350 is attached to an ink supply tube 320 positioned in the mounting portion 300, and the other end of the tube 350 is fitted to a tube joint provided at the sub tank 135. The ink cartridge 10 comprises an ink chamber 11. When the ink cartridge 10 is mounted on the mounting portion 300, the ink chamber 11 and one of the sub tanks 135 are brought into fluid communication with each other via the tube 350. When the ink is discharged from the printhead 132, ink is supplied from the ink chamber 11 to the sub tank 135 accordingly.

<Configuration of Ink Cartridge> Referring now to FIG. 2(A) to FIG. 6, the ink cartridge 10 is described. Referring to FIG. 2(A) and FIG. 2(B), the ink cartridge 10 has a substantially rectangular parallelepiped shape having a width in a widthwise direction 12, a depth in a depthwise direction 13, and a height in a heightwise direction 14. The width of the ink cartridge 10 is less than the depth and the height of the ink cartridge 10.

The ink cartridge 10 comprises a frame 20 and a pair of side walls 21. The frame 20 has a substantially rectangular parallelepiped shape having a width in the widthwise direction 12, a depth in the depthwise direction 13, and a height in the heightwise direction 14. The frame 20 comprises a front wall 22, a back wall 23 opposite the front wall 22 in the depthwise direction 13, an upper wall 24, and a bottom wall 25 opposite the upper wall 24 in the heightwise direction. The upper wall 24 is connected to the front wall 22 and the back wall 23. Similarly, the bottom wall 25 is connected to the front wall 22 and the back wall 23.

The frame 20 is translucent, e.g., transparent or semi-transparent, such that light such as visible light or infrared light can pass through the frame 20. The frame 20 is formed of resin material such as nylon, polyethylene, or polypropylene, for example.

The pair of side walls 21 are connected respectively to both end portions of the frame 20 in the widthwise direction 12. For example, the pair of side walls 21 are respectively welded or bonded by an adhesive agent to the both end portions of the frame 20 in the widthwise direction 12.

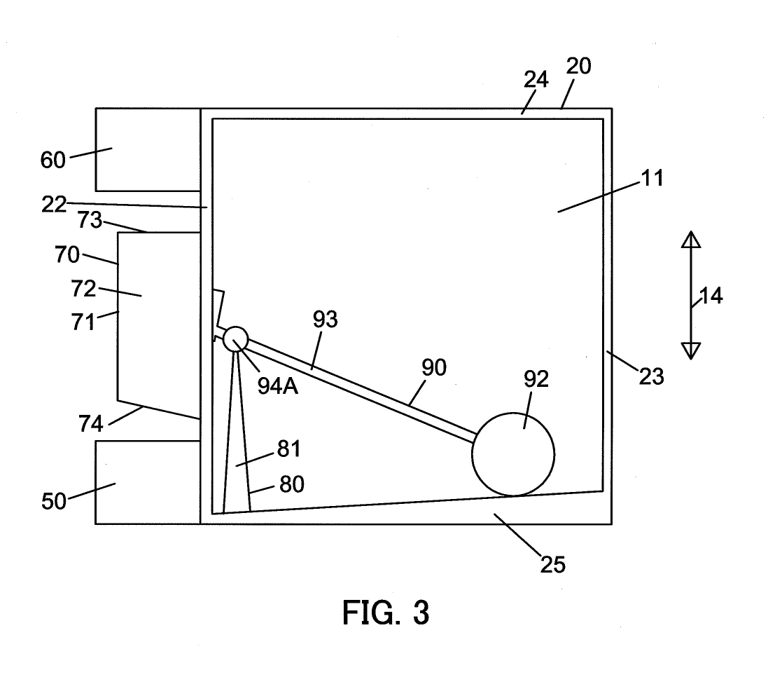

Referring to FIG. 3, the ink chamber 11 is formed in the interior of the frame 20. With the pair of side walls 21 connected to the both end portions of the frame 20 in the widthwise direction 12, the ink chamber 11 is defined by the frame 20 and the pair of side walls 21.

The pair of side walls 21 shown in FIG. 2(A) and FIG. 2(B) are formed of resin material such as nylon, polyethylene, or polypropylene, for example. In the case where the pair of side walls 21 are welded to the both end portions of the frame 20 in the widthwise direction 12, the material of the frame 20 and the materials of the pair of side walls 21 are preferably the same. The pair of side walls 21 may be flexible films. In other words, the pair of side walls 21 may have a thickness allowing the pair of side walls 21 to deform toward the ink chamber 11 when an external force is applied to the pair of side walls 21. For example, the pair of side walls 21 may have a thickness allowing the pair of side walls 21 to deform toward the ink chamber 11 due to the pressure differential between the pressure in the interior of the ink chamber 11 and the atmospheric pressure outside the ink chamber 11 when the pressure in the interior of the ink chamber 11 is reduced to be less than the atmospheric pressure.

<Configuration of Valve Mechanism> Referring to FIG. 2(A) to FIG. 4(B), the ink cartridge 10 comprises an ink supply valve mechanism 50 as an example of a first valve mechanism of the present invention, and an atmospheric air introduction valve mechanism 60 as an example of a second valve mechanism of the present invention, both positioned at the front wall 22 of the frame 20. The ink supply valve mechanism 50 is positioned adjacent to the bottom wall 25 of the frame 20, and the atmospheric air introduction valve mechanism 60 is positioned adjacent to the upper wall 24 of the frame 20.

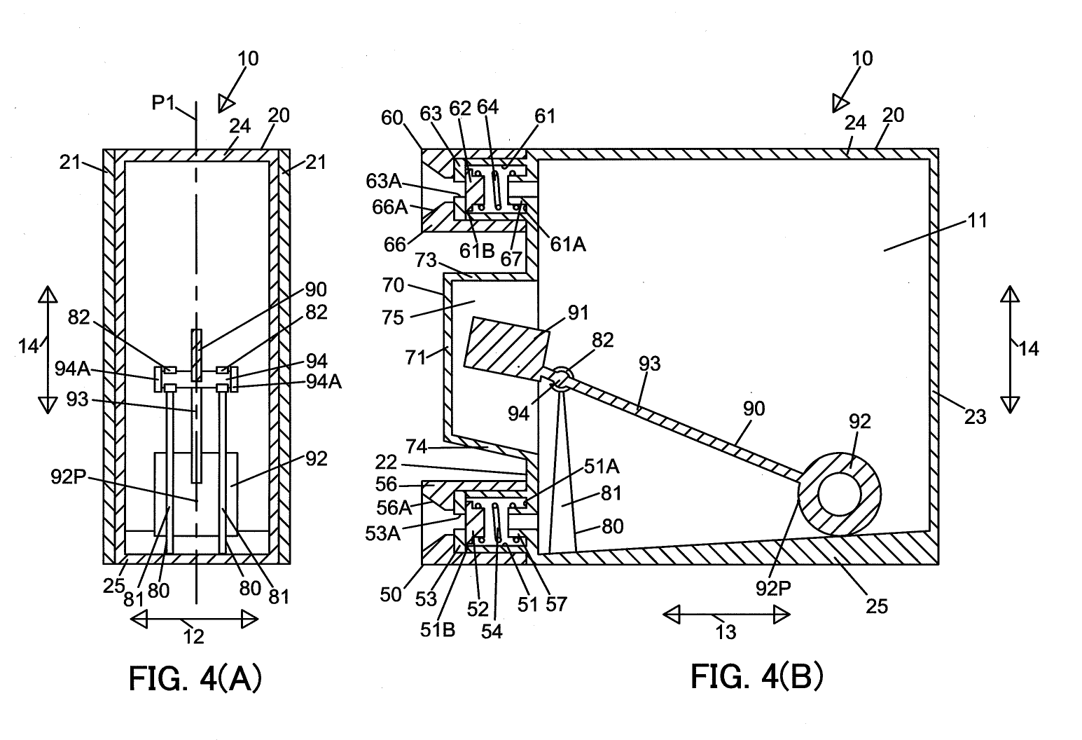

Referring to FIG. 4(B), the ink supply valve mechanism 50 comprises a cylindrical ink supply chamber 51, a valve body 52 formed of resin, a seal member 53 formed of rubber, a coil spring 54 formed of metal, and a cap 56 formed of resin. The ink supply chamber 51 extends away from the ink chamber 11 in the depthwise direction 13 from the front wall 22 of the frame 20, and the ink supply chamber 51 comprises a first end 51A and a second end 51B opposite the first end 51A in the depthwise direction 13. The first end 51A is positioned closer to the ink chamber 11 than the second end 51B is positioned to the ink chamber 11. The ink supply chamber 51 is in fluid communication with the ink chamber 11 at the first end 51A. The second end 51B of the ink supply chamber 51 is opened to the outside of the frame 20, and the seal member 53 is positioned at the second end 51B of the ink supply chamber 51. The seal member 53 has a cylindrical opening 53A formed therethrough in the depthwise direction 13. The cap 56 is welded to the frame 20. The cap 56 has a substantially conical shaped opening 56A formed therethrough in the depthwise direction 13. The seal member 53 is sandwiched between a portion of the frame 20 which defines the second end 51B of the ink supply chamber 51 and the cap 56 while being elastically deformed. Consequently, communication between the ink supply chamber 51 and the outside of the ink cartridge 10 via a contact portion between the portion of the frame 20 which defines the second end 51B of the ink supply chamber 51 and the seal member 53 is blocked.

The valve body 52 and the coil spring 54 are positioned in the ink supply chamber 51. A projection 57 extends from the first end 51A toward the second end 51B of the ink supply chamber 51. The projection 57 is inserted into one end of the coil spring 54, such that the coil spring 54 is attached to the projection 57. The valve body 52 comprises a cylindrical projection, and the projection of the valve body 52 is inserted into the other end of the coil spring 54, such that the coil spring 54 is attached to the valve body 52. The coil spring 54 is compressed, and presses the valve body 52 toward the seal member 53. The valve body 52 is in contact with the seal member 53 and covers an end of the opening 53A. Consequently, the communication between the ink supply chamber 51 and the outside of the ink cartridge 10 via the opening 53A is blocked.

Similarly, the atmospheric air introduction valve mechanism 60 comprises a cylindrical atmospheric air introduction camber 61, a valve body 62 formed of resin, a seal member 63 formed of rubber, a coil spring 64 formed of metal, and a cap 66 formed of resin. The atmospheric air introduction camber 61 extends away from the ink chamber 11 in the depthwise direction 13 from the front wall 22 of the frame 20, and the atmospheric air introduction camber 61 comprises a first end 61A and a second end 61B opposite the first end 61A in depthwise direction 13. The first end 61A is positioned closer to the ink chamber 11 than the second end 61B is positioned to the ink chamber 11. The atmospheric air introduction camber 61 is in fluid communication with the ink chamber 11 at the first end 61A. The second end 61B of the atmospheric air introduction camber 61 is opened to the outside of the frame 20, and the seal member 63 is positioned at the second end 61B of the ink supply chamber 61. The seal member 63 has a cylindrical opening 63A formed therethrough in the depthwise direction 13. The cap 66 is welded to the frame 20. The cap 66 has a substantially conical-shaped opening 66A formed therethrough in the depthwise direction 13. The seal member 63 is sandwiched between a portion of the frame 20 which defines the second end 61B of the atmospheric air introduction camber 61 and the cap 66 while being elastically deformed. Consequently, communication between the atmospheric air introduction camber 61 and the outside of the ink cartridge 10 via a contact portion between the portion of the frame 20 which defines the second end 61B of the atmospheric air introduction camber 61 and the seal member 63 is blocked.

The valve body 62 and the coil spring 64 are positioned in the atmospheric air introduction camber 61. A projection 67 extends from the first end 61A toward the second end 61B of the atmospheric air introduction camber 61. The projection 67 is inserted into one end of the coil spring 64, such that the coil spring 64 is attached to the projection 67. The valve body 62 includes a cylindrical projection, and the projection of the valve body 62 is inserted into the other end of the coil spring 64, such that the coil spring 64 is attached to the valve body 62. The coil spring 64 is compressed, and presses the valve body 62 toward the seal member 63. The valve body 62 is in contact with the seal member 63 and covers an end of the opening 63A. Consequently, the communication between the atmospheric air introduction camber 61 and the outside of the ink cartridge 10 via the opening 63A is blocked.

Referring to FIG. 2(A) to FIG. 4(B), the frame 20 comprises a protrusion 70 at the front wall 22. The protrusion 70 extends away from the back wall 23 from the front wall 22 in the depthwise direction 13. The protrusion 70 has a substantially rectangular parallelepiped shape, and the width of the protrusion 70 is less than the width of the front wall 22 in the widthwise direction 12. The protrusion 70 comprises a front wall 71, a pair of side walls 72 connected to the front wall 71 and the front wall 22, an upper wall 73 connected to the front wall 71, the front wall 22, and the pair of side walls 72, and a bottom wall 74 opposite the upper wall 73 in the heightwise direction 14 and connected to the front wall 71, the front wall 22, and the pair of side walls 72. Referring to FIG. 4(B), the protrusion 70 comprises an inner space 75 defined by the front wall 71, the pair of side walls 72, the upper wall 73, and the bottom wall 74. The inner space 75 is a part of the ink chamber 11. As described above, because the frame 20 is translucent, light such as visible light or infrared light can pass through the protrusion 70.

<Configuration of Pivoting Member> Referring to FIG. 3 to FIG. 4(B), the ink cartridge 10 comprises a pivoting member 90, and the pivoting member 90 is positioned in the ink chamber 11. Referring to FIG. 3 to FIG. 5(B), the ink cartridge 10 comprises a pair of supporting members 80 extending from the bottom wall 25 toward the upper wall 24 of the frame 20. The distance between the pair of supporting members 80 and the front wall 22 is less than the distance between the pair of supporting members 80 and the back wall 23 in the depthwise direction 13. The pivoting member 90 is supported by the pair of supporting members 80 in the ink chamber 11.

Referring to FIG. 3 to FIG. 5(B), the pair of supporting members 80 are aligned in the widthwise direction 12. Each of the pair of supporting members 80 comprises a base 81 and a supporting portion 82. A lower end of the base 81 is connected to the bottom wall 25, and an upper end of the base 81 is connected to the supporting portion 82. The supporting portion 82 has a substantially C-shape in side view. The supporting portion 82 is aligned with the protrusion 70 in the depthwise direction 13.

The pivoting member 90 is formed of resin material such as nylon, polyethylene, polypropylene, polycarbonate, polyolefin, and acryl resin, added with black pigment, for example, carbon black. Since the pivoting member 90 is added with carbon black, when the pivoting member 90 is irradiated with light, for example, visible light or infrared light, the pivoting member 90 blocks the light. In other words, because the pivoting member 90 absorbs the light, i.e., the pivoting member 90 prevents the light from passing therethrough, the light cannot pass through the pivoting member 90. Alternatively, the pivoting member 90 may prevent at least a portion of the light from passing therethrough.

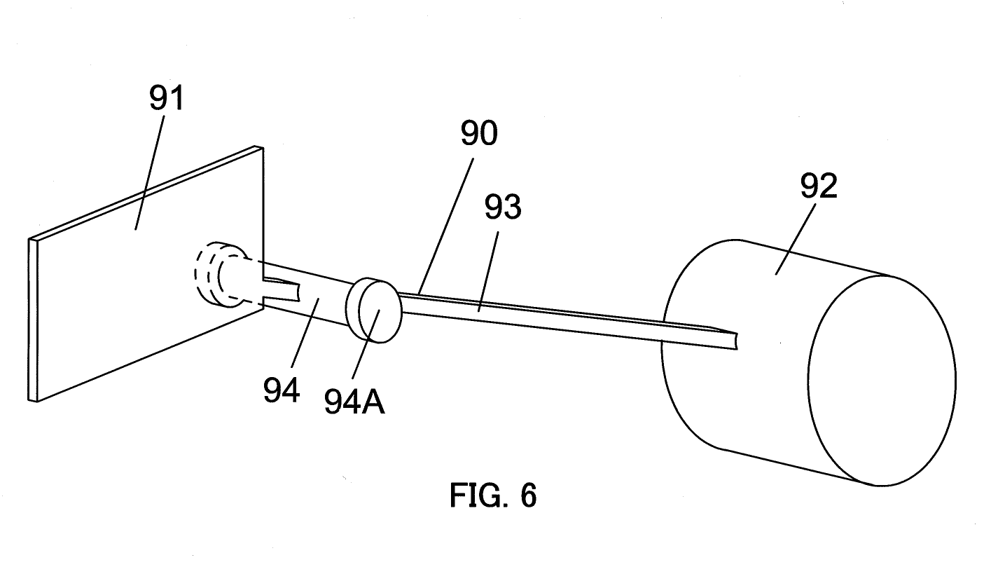

Referring to FIG. 6, the pivoting member 90 comprises a substantially rectangular parallelepiped detected portion 91, a substantially cylindrical floating portion 92, a substantially rectangular parallelepiped connecting portion 93, and a substantially cylindrical shaft 94. One end of the connecting portion 93 is connected to the detected portion 91, and the other end of the connecting portion 93 is connected to the floating portion 92. The shaft 94 extends from the connecting portion 93 in the widthwise direction 12. The shaft 94 is positioned closer to the detected portion 91 than to the floating portion 92.

Referring to FIG. 4(A), the connecting portion 93 of the pivoting member 90 is positioned between the pair of supporting members 80 in the widthwise direction 12. The shaft 94 extends from the connecting portion 93 in the widthwise direction 12 through the interior of a pair of the supporting portions 82. The diameter of the shaft 94 is slightly less than the inner diameter of the supporting portion 82. The pivoting member 90 is supported by the pair of the supporting portions 82 so as to be pivotable about a center axis of the shaft 94 extending in the widthwise direction 12. The center axis of the shaft 94 is the center of pivotal movement of the pivoting member 90. The shaft 94 comprises disk-shaped terminal portions 94A at both ends of the shaft 94 in the widthwise direction 12. The diameter of each of the terminal portions 94A is substantially the same as the outer diameter of the supporting portion 82. The pivoting member 90 is pivotable in a plane parallel to the depthwise direction 13 and the heightwise direction 14 with respect to the ink chamber 11. For example, a point 92P on the floating portion 92 is pivotable in a plane P1 shown by an alternate long and short dash line in FIG. 4(A).

The floating portion 92 has a cavity formed therein such that the specific gravity of the floating portion 92 becomes less than the specific gravity of the ink stored in the ink chamber 11. The volume of the floating portion 92 is greater than the sum of the volumes of the detected portion 91, the connecting portion 93, and the shaft 94. Also, the mass of the floating portion 92 is greater than the sum of the masses of the detected portion 91, the connecting portion 93, and the shaft 94. Therefore, the movement of the pivoting member 90 can be explained from the relationship between the buoyancy and the gravity acting on the floating portion 92. When the floating portion 92 is submerged below the surface of the ink in the ink chamber 11, because the buoyancy acting on the floating portion 92 exceeds the gravity acting on the floating portion 92, the floating portion 92 attempts to float on the ink surface. Therefore, a force to move the pivoting member 90 counterclockwise in FIG. 4(B) acts on the pivoting member 90. In contrast, when the ink surface moves down in accordance with the consumption of the ink in the ink chamber 11 and a portion of the floating portion 92 is exposed from the ink surface, the buoyancy acting on the floating portion 92 is equal to the gravity acting on the floating portion 92. When the ink surface further moved down the floating portion 92 moves down according to the ink surface. In association with the lowering of the floating portion 92, the pivoting member 90 moves clockwise in FIG. 4(B).

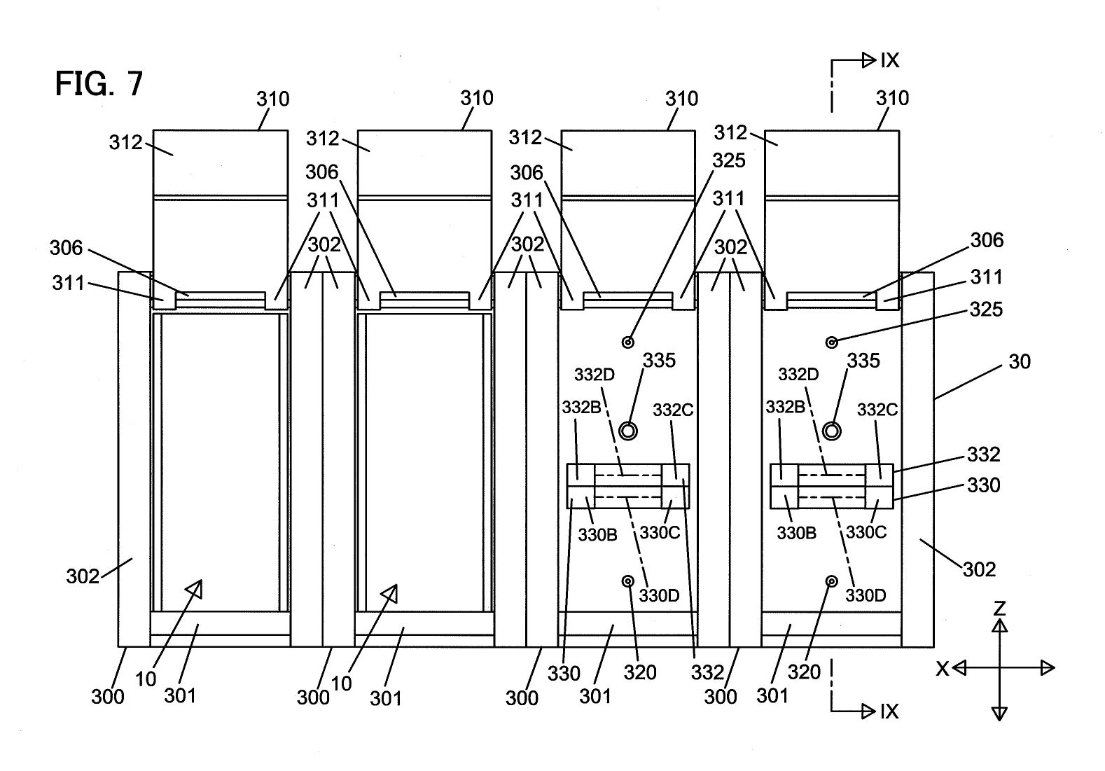

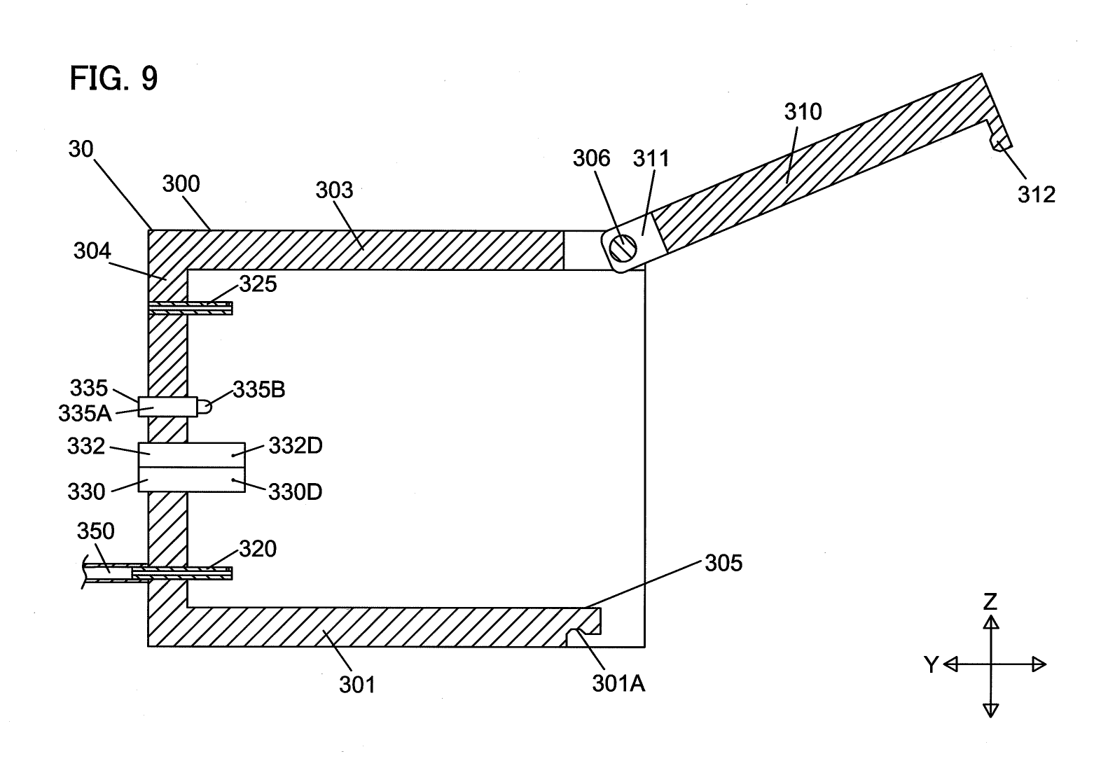

Referring to FIG. 4(B), the detected portion 91 is positioned in the inner space 75 of the protrusion 70.

<Configuration of Ink Supply Device and Mounting portions> Referring to FIG. 7 to FIG. 9, the ink supply device 30 comprising the four mounting portions 300 is described. In the figures, two directions parallel to the horizontal plane and perpendicular to each other are expressed by an X-direction and a Y-direction, and a direction perpendicular to the X-direction and the Y-direction respectively and parallel to the direction of the gravity is expressed as a Z-direction. In FIG. 7, two ink cartridges 10 are mounted to two mounting portions 300 respectively. Although FIG. 9 is a cross-sectional view of the mounting portion 300 taken along the line IX-IX shown in FIG. 7, for the sake of convenience, a first optical sensor 330, a second optical sensor 332, and a limit switch 335 are shown in side views in FIG. 9. Moreover, the positions of an optical path 330D and an optical path 332D are shown in FIG. 9 for the sake of convenience.

Referring to FIG. 7 to FIG. 9, each of the mounting portions 300 has a substantially rectangular parallelepiped shape. Each of the mounting portions 300 comprises a bottom wall 301, a pair of side walls 302, an upper wall 303, and a back wall 304. The pair of side walls 302 extend in the Z-direction respectively from both end portions of the bottom wall 301 in the X-direction. The upper wall 303 is bridged between end portions of the pair of side walls 302 on the opposite side from the bottom wall 301. The back wall 304 is connected to the bottom wall 301, the pair of side walls 302, and the upper wall 303. An opening 305 is defined by the bottom wall 301, the pair of side walls 302, and the end portion of the upper wall 303 on the opposite side from the back wall 304. A lower surface of the end portion of the bottom wall 301 on the opposite side from the back wall 304 is has a recessed portion 301A formed therein. The ink cartridge 10 is configured to be removably mounted to the mounting portion 300 by being inserted into the mounting portion 300 from the opening 305 toward the back wall 304 along an insertion direction parallel to the Y-direction. Therefore, the back wall 304 is positioned at an end portion of the mounting portion 300 with respect to the insertion direction.

A cylindrical shaft 306 extends from one of the pair of side walls 302 to the other one of those in the X-direction. The shaft 306 is aligned with the upper wall 303 in the Y-direction. The shaft 306 is positioned adjacent to an end of the upper wall 303 on the opposite side from the back wall 304.

The ink supply device 30 further comprises four substantially rectangular parallelepiped doors 310. The four doors 310 are positioned respectively corresponding to the four mounting portions 300. One end of the door 310 comprises two projections 311. Each of the projections 311 has an opening formed therethrough in the X-direction. The shaft 306 extends through the openings formed in the respective projections 311, and the door 310 is supported by the shaft 306 so as to be pivotable about the shaft 306. The other end of the door 310 comprises a claw 312. When the door 310 is closed, that is, when the door 310 is moved toward the mounting portion 300, and the claw 312 is engaged with the recessed portion 301A, the opening 305 is covered with the door 310.

<Configuration of Valve Opening Members> Referring to FIG. 7 and FIG. 9, the ink supply device 30 comprises four cylindrical ink supply tubes 320. Two of the four ink supply tubes 320 are shown in FIG. 7, while one of the four ink supply tubes 320 is shown in FIG. 9. The four ink supply tubes 320 are positioned respectively corresponding to the four mounting portions 300. The ink supply tube 320 is fixed to the back wall 304 of the mounting portion 300, and projects from the back wall 304 toward the opening 305. The ink supply tube 320 extends through the back wall 304 to the outside of the mounting portion 300. The ink supply tube 320 is attached to the tube 350 by being inserted into the interior of the tube 350 at the outside of the mounting portion 300. In addition, attachment of the tube 350 and the ink supply tube 320 may further be ensured by bringing a circular clamp (band) into contact with an outer periphery of the tube 350 and fastening the clamp. The ink supply tube 320 is an example of a first valve opening member of the present invention.

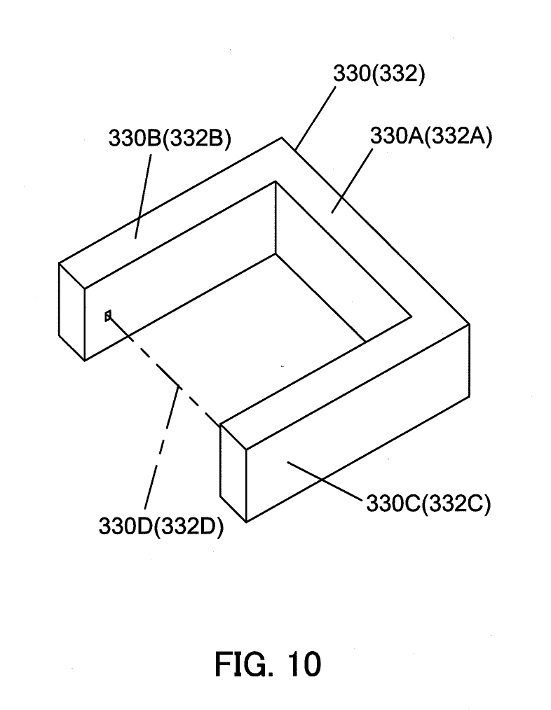

Referring to FIG. 7 and FIG. 9, the ink supply device 30 comprises four cylindrical atmospheric air introduction tubes 325. Two of the four atmospheric air introduction tubes 325 are shown in FIG. 7, while one of the four atmospheric air introduction tubes 325 is shown in FIG. 9. The four atmospheric air introduction tubes 325 are positioned respectively corresponding to the four mounting portions 300. The atmospheric air introduction tube 325 is fixed to the back wall 304 of the mounting portion 300, and projects from the back wall 304 toward the opening 305. The atmospheric air introduction tube 325 extends through the back wall 304 and reaches an outside surface of the mounting portion 300. The atmospheric air introduction tube 325 is an example of a second valve opening member of the present invention.

<Configuration of Optical detectors> Referring to FIG. 7 and FIG. 9, the ink jet printer 100 comprises four first optical sensors 330 as an example of the first optical detector of the present invention. Two of the four first optical sensors 330 are shown in FIG. 7, while one of the four first optical sensors 330 is shown in FIG. 9. The four first optical sensors 330 are positioned respectively corresponding to the four mounting portions 300. FIG. 10 is a perspective view of the first optical sensor 330. Referring to FIG. 10, each of the first optical sensors 330 comprises a substantially rectangular parallelepiped base portion 330A, a substantially rectangular parallelepiped light-emitting portion 330B, and a substantially rectangular parallelepiped light-receiving portion 330C. The first optical sensor 330 is positioned in an opening formed through the back wall 304 of the mounting portion 300 in the Y-direction, and is fixed to the back wall 304. The first optical sensor 330 is positioned above the ink supply tube 320, and is positioned below the atmospheric air introduction tube 325. The light-emitting portion 330B extends from one end of the base portion 330A in the X-direction toward the opening 305 of the mounting portion 300. The light-receiving portion 330C extends from the other end of the base portion 330A in the X-direction toward the opening 305 of the mounting portion 300. The light-emitting portion 330B and the light-receiving portion 330C are aligned in the X-direction. The light-emitting portion 330B has formed with a rectangular slit in a surface facing the light-receiving portion 330C. The light-emitting portion 330B emits light, for example, visible light or infrared light toward the light-receiving portion 330C via the slit formed in the light-emitting portion 330B. The light-receiving portion 3300 is formed with a rectangular slit (not shown) in a surface facing the light-emitting portion 330B. The light-receiving portion 330C receives the light emitted from the light-emitting portion 330B via the slit formed in the light-receiving portion 330C. The optical path 330D is formed between the light-emitting portion 330B and the light-receiving portion 330C.

When the light-receiving portion 330C receives the light emitted from the light-emitting portion 330B with an intensity greater than or equal to a predetermined intensity, the light-receiving portion 330C outputs a voltage which is higher than or equal to a predetermined voltage. When the light-receiving portion 330C receives the light emitted from the light-emitting portion 330B with an intensity less than the predetermined intensity, the light-receiving portion 330C outputs a voltage which is lower than the predetermined voltage. “When the light-receiving portion 330C receives the light emitted from the light-emitting portion 330B with an intensity less than the predetermined intensity” comprises “when the light-receiving portion 330C does not receive the light emitted from the light-emitting portion 330B at all”, i.e., “when the intensity of the light received by the light-receiving portion 330C receives is zero”. Also, “the light-receiving portion 330C outputs a voltage which is lower than the predetermined voltage” comprises “the light-receiving portion 330C does not output the voltage at all”, i.e., “the voltage value outputted by the light-receiving portion 330C is a ground level”. In this manner, the light-receiving portion 330C selectively assumes two states. A control unit 400 of the ink-jet printer 100, described later, determines that the light-receiving portion 330C is in an ON state when the light-receiving portion 330C outputs the voltage which is higher than or equal to the predetermined voltage, and determines that the light-receiving portion 330C is in an OFF state when the light-receiving portion 330C outputs the voltage which is lower than the predetermined voltage.

Referring to FIG. 7 and FIG. 9, the ink-jet printer 100 comprises four second optical sensors 332 as an example of the second optical detector of the present invention. Two of the four second optical sensors 332 are shown in FIG. 7, while one of the four second optical sensors 332 is shown in FIG. 9. The four second optical sensors 332 are positioned respectively corresponding to the four mounting portions 300. The second optical sensor 332 has the same structure as the first optical sensor 330. Therefore, FIG. 10 also is a perspective view of the second optical sensor 332. Referring to FIG. 10, each of the second optical sensors 330 comprises a substantially rectangular parallelepiped base portion 332A, a substantially rectangular parallelepiped light-emitting portion 332B, and a substantially rectangular parallelepiped light-receiving portion 332C. The second optical sensor 332 is positioned in an opening formed through the back wall 304 of the mounting portion 300 in the Y-direction, and is fixed to the back wall 304. The second optical sensor 332 is positioned above the ink supply tube 320, and is positioned below the atmospheric air introduction tube 325. The second optical sensor 332 is positioned above the first optical sensor 330. The light-emitting portion 332B extends from one end of the base portion 332A in of the X-direction toward the opening 305 of the mounting portion 300. The light-receiving portion 332C extends from the other end of the base portion 332A in the X-direction toward the opening 305 of the mounting portion 300. The light-emitting portion 332B and the light-receiving portion 332C are aligned in the X-direction. The light-emitting portion 332B is aligned with the light-emitting portion 330B of the first optical sensor in the Z-direction, and the light-receiving portion 332C is aligned with the light-receiving portion 330C of the first optical sensor in the Z-direction. The light-emitting portion 332B is formed with a rectangular slit in a surface opposing the light-receiving portion 332C. The light-emitting portion 332B emits light, for example, visible light or infrared light toward the light-receiving portion 332C via the slit formed in the light-emitting portion 332B. The light-receiving portion 332C is formed with a rectangular slit (not shown) in a surface opposing the light-emitting portion 332B. The light-receiving portion 332C receives the light emitted from the light-emitting portion 332B via the slit formed in the light-receiving portion 332C. The optical path 332D is formed between the light-emitting portion 332B and the light-receiving portion 332C. A wavelength of the light emitted from the light-emitting portion 332B may be different from a wavelength of the light emitted from the light-emitting portion 330B of the first optical sensor 330.

When the light-receiving portion 332C receives the light emitted from the light-emitting portion 332B with an intensity greater than or equal to a predetermined intensity, the light-receiving portion 332C outputs a voltage which is higher than or equal to a predetermined voltage. When the light-receiving portion 332C receives the light emitted from the light-emitting portion 332B with an intensity less than the predetermined intensity, the light-receiving portion 332C outputs a voltage which is lower than the predetermined voltage. “When the light-receiving portion 332C receives the light emitted from the light-emitting portion 332B with an intensity less than the predetermined intensity” comprises “when the light-receiving portion 332C does not receive the light emitted from the light-emitting portion 332B at all”, i.e., “when the intensity of the light received by the light-receiving portion 332C receives is zero”. Also, “the light-receiving portion 332C outputs a voltage which is lower than the predetermined voltage” comprises “the light-receiving portion 332C does not output the voltage at all”, i.e., “the voltage value outputted by the light-receiving portion 332C is a ground level”. In this manner, the light-receiving portion 332C selectively assumes two states. The control unit 400 of the ink jet printer 100, described alter, determines that the light-receiving portion 332C is in an ON state when the light-receiving portion 332C outputs the voltage which is higher than or equal to the predetermined voltage, and determines that the light-receiving portion 332C is in an OFF state when the light-receiving portion 332C outputs the voltage which is lower than the predetermined voltage.

<Configuration of limit switches> Referring to FIG. 7 and FIG. 9, the ink-jet printer 100 comprises four limit switches 335 which detects the fact that the ink cartridges 10 are mounted to the mounting portions 300. Two of the four limit switches 335 are shown in FIG. 7, while one of the four limit switches 335 is shown in FIG. 9. The four limit switches 335 are positioned respectively corresponding to the four mounting portions 300. The limit switch 335 is positioned in an opening formed through the back wall 304 of the mounting portion 300 in the Y-direction, and is fixed to the back wall 304. The limit switch 335 comprises a case 335A, and an actuator 335B extending from the interior of the case 335A to the exterior of the case 335A and being capable of moving with respect to the case 335A. In the interior of the case 335A, a movable contact (not shown) is fixed to the actuator 335B. The movable contact is movable together with the actuator 335B with respect to the case 335A. In the interior of the case 335A, a fixed contact (not shown) fixed to the case 335A. Depending on the position of the actuator 335B with respect to the case 335A, the movable contact can selectively assume a state in which the movable contact is in contact with the fixed contact and a state in which the movable contact is separated from the fixed contact.

When the movable contact is in contact with the fixed contact, the limit switch 335 outputs a voltage which is higher than or equal to a predetermined voltage. When the movable contact is separated from the fixed contact, the limit switch 335 outputs the voltage which is lower than the predetermined voltage. “The limit switch 335 outputs a voltage which is lower than the predetermined voltage” comprises “the limit switch 335 does not output the voltage at all”, i.e., “the voltage outputted by the limit switch 335 is a ground level”. In this manner, the limit switch 335 selectively assumes two states. The control unit 400 of the ink-jet printer 100, described alter, determines that the limit switch 335 is in an ON state when the limit switch 335 outputs the voltage higher than or equal to the predetermined voltage, and determines that the limit switch 335 is in an OFF state when the limit switch 335 outputs the voltage which is lower than the predetermined voltage. When the ink cartridge 10 is not mounted to the mounting portion 300, the movable contact of the limit switch 335 is separated from the fixed contact and therefore the limit switch 335 is determined to be in the OFF state.

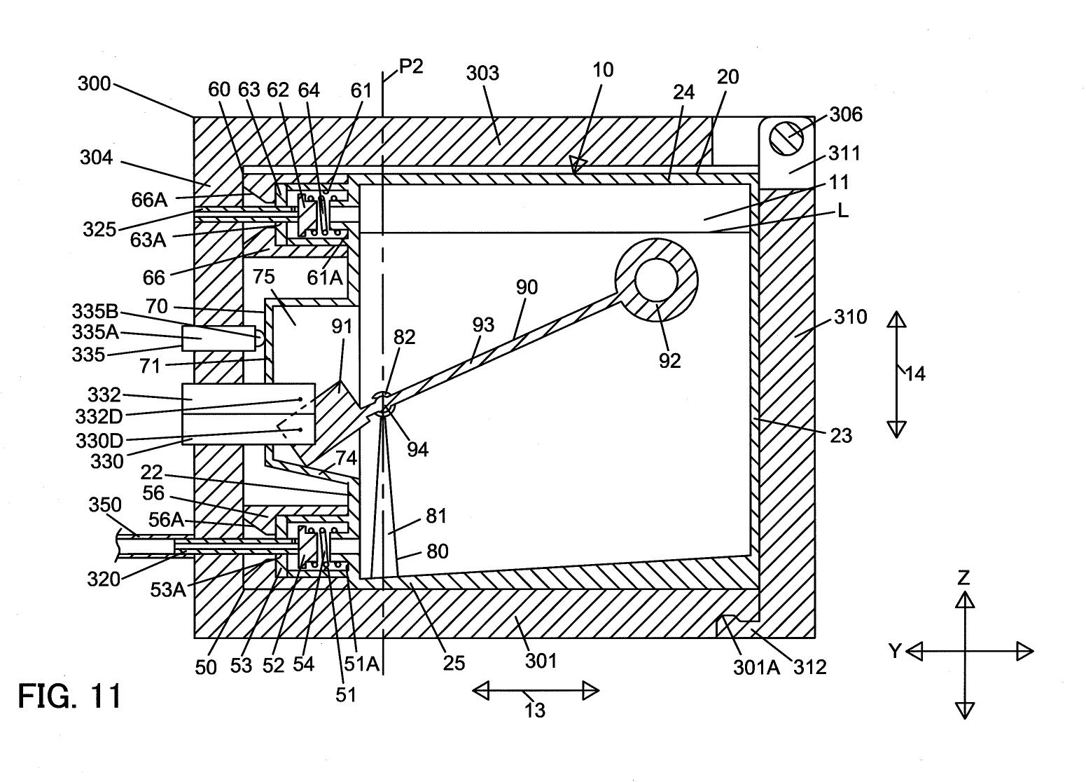

The ink supply tube 320, the atmospheric air introduction tube 325, the first optical sensor 330, the second optical sensor 332, and the limit switch 335 are aligned in the Z-direction.

<Relationship between Mounting portion and Ink Cartridge> Although FIG. 11 is a cross-sectional view, for the sake of convenience, the first optical sensor 330, the second optical sensor 332, and the limit switch 335 are shown in side views in FIG. 11. The door 310 is closed in FIG. 11. When the ink cartridge 10 is mounted to the mounting portion 300, the widthwise direction 12 is aligned with the X-direction, the depthwise direction 13 is aligned with the Y-direction, and the heightwise direction 14 is aligned with the Z-direction.

Referring to FIG. 11, when the ink cartridge 10 is mounted to the mounting portion 300 and the door 310 is closed, the floating portion 92 and the detected portion 91 are positioned in such a manner that a plane P2 is positioned between the floating portion 92 and the detected portion 91. The plane P2 is a plane which is perpendicular to a plane extending in parallel to the depthwise direction 13 and the heightwise direction 14. The plane P2 intersects the center of pivotal movement of the pivoting member 90, and the plane P2 extends in parallel to the Z-direction. The plane extending in parallel to the depthwise direction 13 and the heightwise direction 14 is the plane P1 shown in FIG. 4(A), for example.

Referring to FIG. 11, when the ink cartridge 10 is mounted to the mounting portion 300, and the door 310 is closed, the protrusion 70 is positioned between the light-emitting portion 330B and the light-receiving portion 330C of the first optical sensor 330, and one of the pair of side walls 72 faces the light-emitting portion 330B and the other one of those faces the light-receiving portion 330C. When this occurs, the optical path 330D intersects the pair of side walls 72. The light-emitting portion 330B emits light in a direction intersecting a path along which the detected portion 91 moves with respect to the ink chamber 11 and the first optical sensor 330 in association with the pivotal movement of the pivoting member 90. In other words, the optical path 330D intersects the path along which the detected portion 91 moves with respect to the ink chamber 11 and the first optical sensor 330 in association with the pivotal movement of the pivoting member 90. When the optical path 330D intersects the detected portion 91, the detected portion 91 blocks the light emitted from the light-emitting portion 330B. When this occurs, the state of the light-receiving portion 330C is determined to be the OFF state. When the optical path 330D does not intersect the detected portion 91, the light emitted from the light-emitting portion 330B passes through the pair of side walls 72, and reaches the light-receiving portion 330C. When this occurs, the state of the light-receiving portion 330C is determined to be the ON state.

Similarly, when the ink cartridge 10 is mounted to the mounting portion 300, and the door 310 is closed, the protrusion 70 is positioned between the light-emitting portion 332B and the light-receiving portion 332C of the second optical sensor 332, and one of the pair of side walls 72 faces the light-emitting portion 332B and the other one of those faces the light-receiving portion 332C. When this occurs, the optical path 332D intersects the pair of side walls 72. The light-emitting portion 332B emits light in a direction intersecting the path along which the detected portion 91 moves with respect to the ink chamber 11 and the second optical sensor 332 in association with the pivotal movement of the pivoting member 90. In other words, the optical path 332D intersects the path along which the detected portion 91 moves with respect to the ink chamber 11 and the second optical sensor 332 in association with the pivotal movement of the pivoting member 90. When the optical path 332D intersects the detected portion 91, the detected portion 91 blocks the light emitted from the light-emitting portion 332B. When this occurs, the state of the light-receiving portion 332C is determined to be the OFF state. When the optical path 332D does not intersect the detected portion 91, the light emitted from the light-emitting portion 332B passes through the pair of side walls 72, and reaches the light-receiving portion 332C. When this occurs, the state of the light-receiving portion 332C is determined to be the ON state.

Referring to FIG. 11, when the ink cartridge 10 is mounted to the mounting portion 300, the front wall 71 of the protrusion 70 comes into contact with the actuator 335B of the limit switch 335, and pushes the actuator 335B into the case 335A. When this occurs, the movable contact of the limit switch 335 comes into contact with the fixed contact and the limit switch 335 is determined to be in the ON state. In this manner, by the limit switch 335, the fact that the ink cartridge 10 is mounted to the mounting portion 300 can be detected.

Referring to FIG. 11, when the ink cartridge 10 is mounted to the mounting portion 300, the ink supply tube 320 opens the ink supply valve mechanism 50. In other words, the ink supply tube 320 passes through the opening 56A of the cap 56 and the opening 53A of the seal member 53, and pushes the valve body 52 toward the first end 51A of the ink supply chamber 51 against a force of the coil spring 54 pushing the valve body 52. When this occurs, the seal member 53 comes into contact with the outer periphery of the ink supply tube 320 while being elastically deformed. The valve body 52 moves away from the seal member 53 when being pushed toward the first end 51A of the ink supply chamber 51. Consequently, the ink supply chamber 51 is brought into communication with the tube 350 via the ink supply tube 320. Therefore, the ink chamber 11 is brought into communication with the sub tank 135 via the ink supply chamber 51, the ink supply tube 320, and the tube 350, such that that supply of the ink from the ink chamber 11 to the sub tank 135 is enabled.

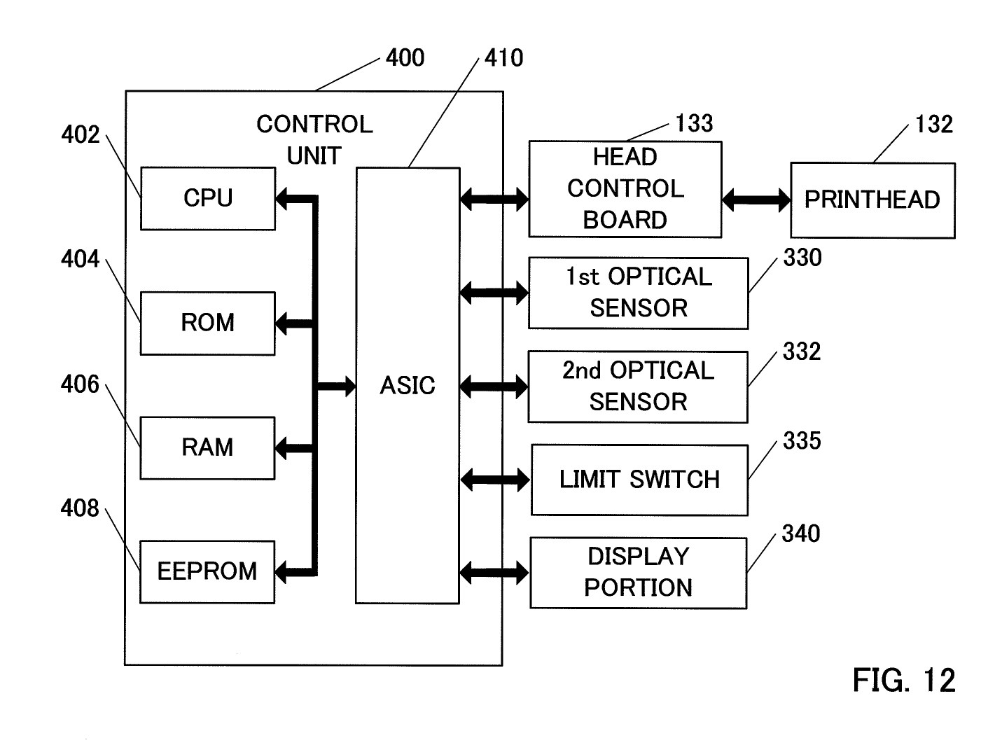

Referring to FIG. 11, when the ink cartridge 10 is mounted to the mounting portion 300, the atmospheric air introduction tube 325 opens the atmospheric air introduction valve mechanism 60. In other words, the atmospheric air introduction tube 325 passes through the opening 66A of the cap 66 and the opening 63A of the seal member 63, and pushes the valve body 62 toward the first end 61A of the atmospheric air introduction camber 61 against a force of the coil spring 64 pushing the valve body 62. When this occurs, the seal member 63 comes into contact with the outer periphery of the atmospheric air introduction tube 325 while being elastically deformed. The valve body 62 moves away from the seal member 63 when being pushed toward the first end 61A of the atmospheric air introduction camber 61. Consequently, the atmospheric air introduction camber 61 is brought into communication with a space outside the mounting portion 300 via the atmospheric air introduction tube 325. Therefore, the ink chamber 11 is brought into communication with the space outside of the mounting portion 300 via the atmospheric air introduction camber 61 and the atmospheric air introduction tube 325, such that introduction of atmospheric air from the space outside the mounting portion 300 into the ink chamber 11 is enabled.

<Electrical Configuration> Referring to FIG. 12, the ink-jet printer 100 comprises the control unit 400. The control unit 400 is configured to control the operation of the ink-jet printer 100, and perform various determinations. The control unit 400 is configured as a microcomputer mainly comprising a Central Processing Unit (CPU) 402, a Read-Only Memory (ROM) 404, a Random Access Memory (RAM) 406, an Electrically Erasable Programmable Read-Only Memory (EEPROM) 408, and an Application Specific Integrated Circuit (ASIC) 410.

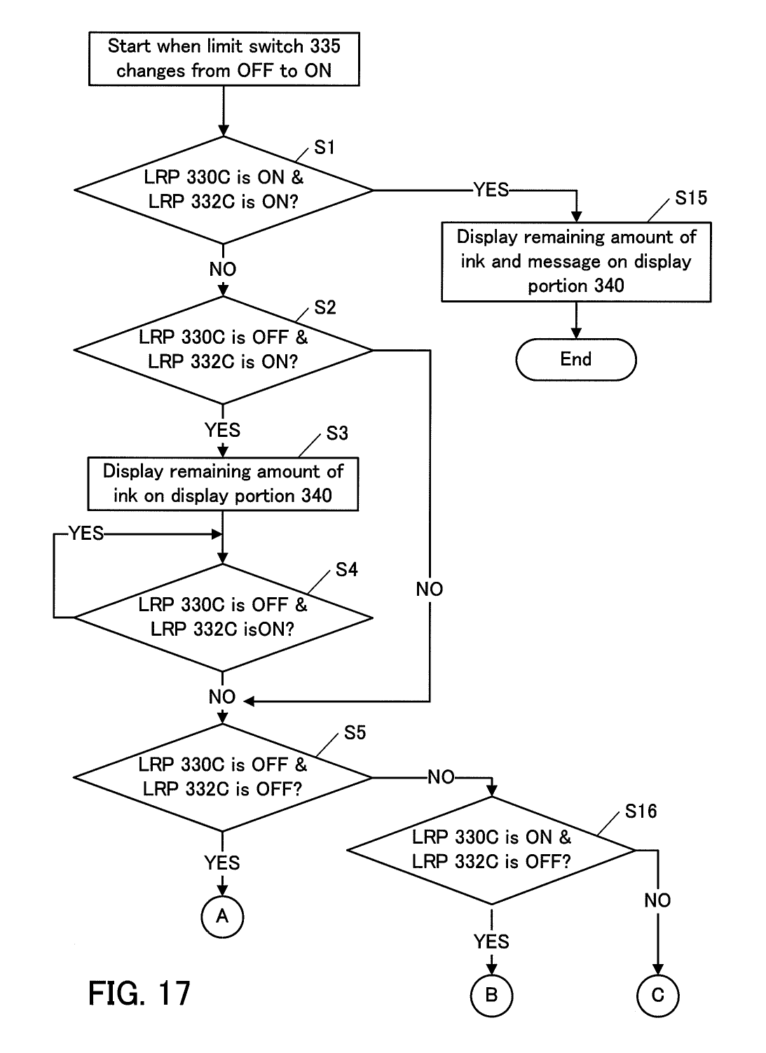

The ROM 404 stores programs for the CPU 402 to control various actions of the ink jet printer 100 and to perform various determinations, such as a program for performing processes shown in flowcharts in FIG. 17 to FIG. 20, which are described later. The RAM 406 is used as a storage area or a working area for storing various data temporarily when the CPU 402 executes the programs described above. The EEPROM 408 stores data to be held even after a power of the ink-jet printer 100 is turned off.

The head control board 133, the first optical sensor 330, the second optical sensor 332, the limit switch 335, and a display portion 340 are electrically connected to the ASIC 410. Although not shown in the drawing, a drive circuit for driving the paper feeding device 110 and the transporting device 120, an input/output portion for inputting and outputting signals with respect to an external personal computer, or an instruction input portion used by a user for issuing printing instruction or the like to the ink-jet printer 100, are also electrically connected to the ASIC 410.

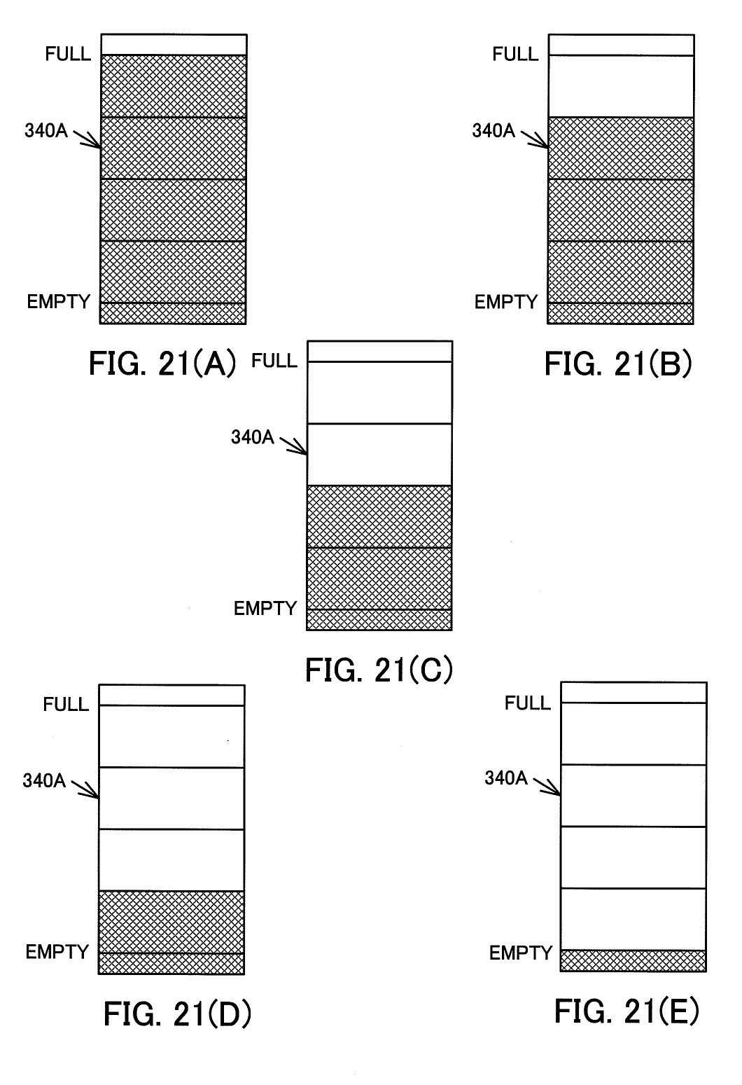

The display portion 340 displays various information for the user, and is a liquid crystal display (abbreviated as LCD), for example. The display portion 340 comprising a remaining amount display portion 340A (see FIG. 21(A) to FIG. 21(E)) which displays the remaining amount of ink stored in the ink cartridge 10.

The control unit 400 sends signals to the head control board 133 upon receipt of printing instruction from the external personal computer (not shown) or the instruction input portion (not shown). The head control board 133 is configured to control ink discharge from the printhead 132 on the basis of the signal received from the control unit 400.

Each of the light-emitting portion 330B of the first optical sensor 330 and the light-emitting portion 332B of the second optical sensor 332 is configured to emit light, for example, visible light or infrared light, upon receipt of a signal from the control unit 400.

The control unit 400 is configured to determine whether each of the state of the light-receiving portion 330C of the first optical sensor 330 and the state of the light-receiving portion 332C of the second optical sensor 332 is in the ON state or in the OFF state as needed. The control unit 400 is configured to determine the remaining amount of ink stored in the ink cartridge 10 mounted to the mounting portion 300 by determining the state of the light-receiving portion 330C of the first optical sensor 330 and the state of the light-receiving portion 332C of the second optical sensor 332 according to a predetermined plurality of steps as shown in the flowcharts in FIG. 17 to FIG. 20. Also, the control unit 400 causes the remaining amount display portion 340A of the display portion 340 to display the remaining amount of ink according to the result of determination described above.

<Operation and Action> Operations and actions of this embodiment configured as described above are described.

Referring to FIG. 11 and FIG. 13 to FIG. 16, the movement of the pivoting member 90 according to the lowering of the surface of the ink in the ink chamber 11 is described.

A new ink cartridge 10 contains ink of an amount which causes the pivoting member 90 to submerge in the ink in the ink chamber 11. In other words, the pivoting member 90 is positioned under the ink surface in the ink chamber 11. Referring to FIG. 11, in a state in which the ink cartridge 10 is mounted to the mounting portion 300, the floating portion 92 attempts to approach an ink surface L in the ink chamber 11. When the floating portion 92 attempts to approach the ink surface L, the pivoting member 90 attempts to move counterclockwise in FIG. 11. However, because the detected portion 91 is in contact with the bottom wall 74, the movement of the pivoting member 90 is prevented, and the pivoting member 90 maintains a position in which the detected portion 91 is in contact with the bottom wall 74. At this position, the floating portion 92 is positioned higher than the first optical sensor 330, the second optical sensor 332, and the supporting portion 82. Because the detected portion 91 intersects the optical path 330D of the first optical sensor 330, when the light is emitted from the light-emitting portion 330B, the detected portion 91 blocks the light. In other words, when the light is emitted from the light-emitting portion 330B, the light-receiving portion 330C is determined to be in the OFF state. In contrast, because the detected portion 91 does not intersect the optical path 332D of the second optical sensor 332, when the light is emitted from the light-emitting portion 332B, the light passes through the pair of side walls 72 of the protrusion 70 and reaches the light-receiving portion 332C. In other words, when the light is emitted from the light-emitting portion 332B, the light-receiving portion 332C is determined to be in the ON state.

When the printhead 132 discharges ink onto a sheet of the printing paper, ink is supplied from the ink chamber 11 to the sub tank 135 accordingly. When the ink in the ink chamber 11 is consumed, the ink surface L in the ink chamber 11 is lowered.

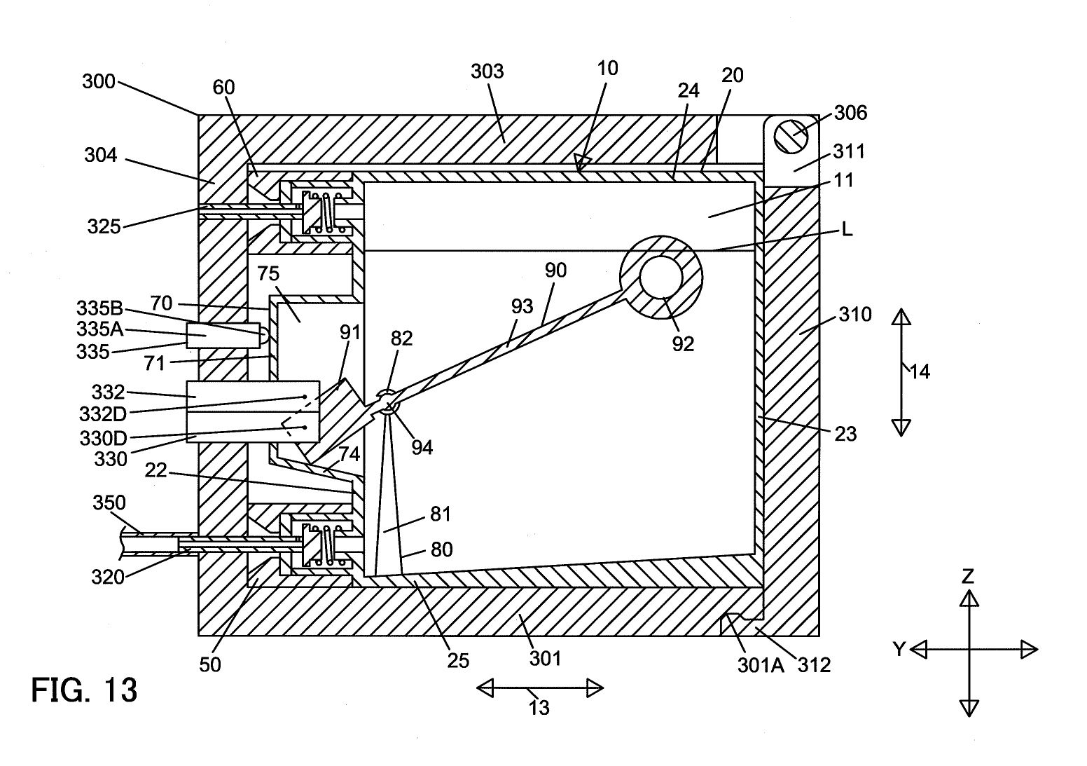

When ink is supplied from the ink chamber 11 to the sub tank 135, and the ink surface L in the ink chamber 11 reaches the first ink surface position, a portion of the floating portion 92 of the pivoting member 90 is exposed in the air in the ink chamber 11 from the ink surface L as shown in FIG. 13, and the gravity and the buoyancy acting on the floating portion 92 becomes equal. The first ink surface position is higher than the first optical sensor 330, the second optical sensor 332, and the supporting portion 82. Also, when the ink surface L is at the first ink surface position, the floating portion 92 is positioned higher than the first optical sensor 330, the second optical sensor 332, and the supporting portion 82.

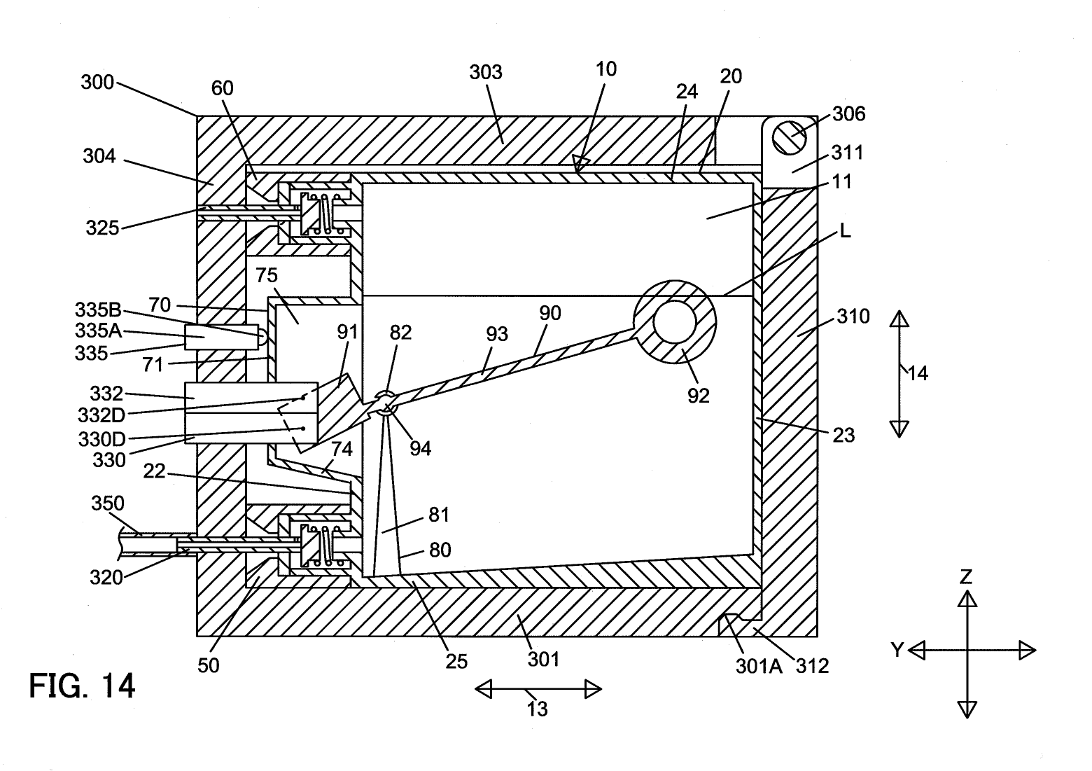

When ink is further supplied from the ink chamber 11 to the sub tank 135, the pivoting member 90 moves clockwise in FIG. 13 in association with the lowering of the ink surface L. Referring to FIG. 14, when the ink surface L reaches the second ink surface position, the detected portion 91 intersects the optical path 330D of the first optical sensor 330 and also intersects the optical path 332D of the second optical sensor 332. At this state, when the light is emitted from the light-emitting portion 330B of the first optical sensor 330, the detected portion 91 blocks the light. In other words, when the light is emitted from the light-emitting portion 330B, the light-receiving portion 330C is determined to be in the OFF state. Also, when the light is emitted from the light-emitting portion 332B of the second optical sensor 332, the detected portion 91 blocks the light. In other words, when the light is emitted from the light-emitting portion 332B, the light-receiving portion 332C is determined to be in the OFF state. The second ink surface position is higher than the first optical sensor 330, the second optical sensor 332, and the supporting portion 82. Also, when the ink surface L is at the second ink surface position, the floating portion 92 is positioned higher than the first optical sensor 330, the second optical sensor 332, and the supporting portion 82.

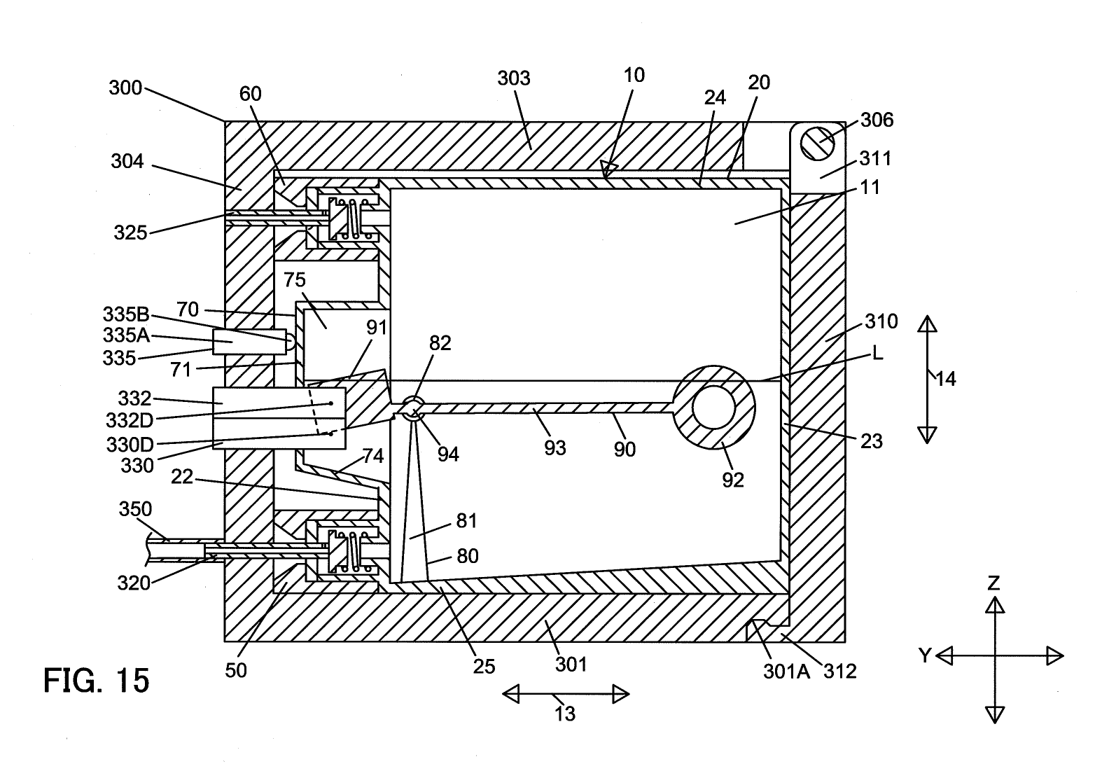

When ink is further supplied from the ink chamber 11 to the sub tank 135, the pivoting member 90 moves clockwise in FIG. 14 in association with the lowering of the ink surface L. Referring to FIG. 15, when the ink surface L reaches the third ink surface position, the detected portion 91 does not intersect the optical path 330D of the first optical sensor 330, but intersects the optical path 332D of the second optical sensor 332. At this state, when the light is emitted from the light-emitting portion 330B of the first optical sensor 330, the light passes through the pair of side walls 72 of the protrusion 70 and reaches the light-receiving portion 330C. In other words, when the light is emitted from the light-emitting portion 330B, the light-receiving portion 330C is determined to be in the ON state. On the other hand, when the light is emitted from the light-emitting portion 332B of the second optical sensor 332, the detected portion 91 blocks the light. In other words, when the light is emitted from the light-emitting portion 332B, the light-receiving portion 332C is determined to be in the OFF state. The third ink surface position is at substantially the same height as the first optical sensor 330, the second optical sensor 332, and the supporting portion 82. Also, when the ink surface L is at the third ink surface position, the floating portion 92 is positioned substantially at the same height as the first optical sensor 330, the second optical sensor 332, and the supporting portion 82.

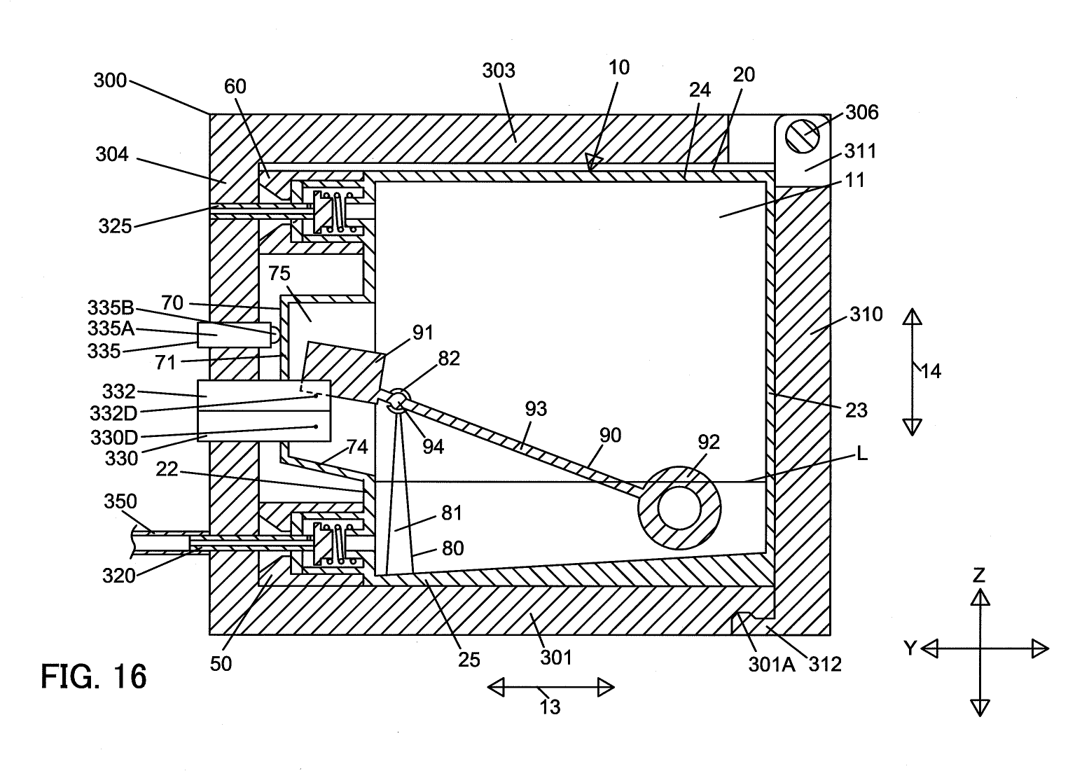

When the ink is further supplied from the ink chamber 11 to the sub tank 135, the pivoting member 90 moves clockwise in FIG. 15 in association with the lowering of the ink surface L. Referring to FIG. 16, when the ink surface L reaches the fourth ink surface position, the detected portion 91 does not intersect the optical path 330D of the first optical sensor 330 and does not the optical path 332D of the second optical sensor 332. At this state, when the light is emitted from the light-emitting portion 330B of the first optical sensor 330, the light passes through the pair of side walls 72 of the protrusion 70 and reaches the light-receiving portion 330C. In other words, when the light is emitted from the light-emitting portion 330B, the light-receiving portion 330C is determined to be in the ON state. Also, when the light is emitted from the light-emitting portion 332B of the second optical sensor 332, the light passes through the pair of side walls 72 of the protrusion 70 and reaches the light-receiving portion 332C. In other words, when the light is emitted from the light-emitting portion 332B, the light-receiving portion 332C is determined to be in the ON state. The fourth ink surface position is lower than the first optical sensor 330, the second optical sensor 332, and the supporting portion 82. Also, when the ink surface L is at the fourth ink surface position, the floating portion 92 is positioned lower than the first optical sensor 330, the second optical sensor 332, and the supporting portion 82.

The control unit 400 monitors the state of the limit switch 335 and starts the determination of FIG. 17 to FIG. 20 when the state of the limit switch 335 is changed from the OFF state to the ON state. In other words, the determination process of FIG. 17 to FIG. 20 is started when the fact that the ink cartridge 10 is mounted to the mounting portion 300 is detected.

In the following description, respective steps in the determination process of FIG. 17 to FIG. 20 are abbreviated as “S”. Referring to FIG. 17 to FIG. 20, when the determination process is started, the control unit 400 causes the light-emitting portion 330B of the first optical sensor 330 and the light-emitting portion 332B of the second optical sensor 332 to emit light and determines whether or not the state of the light-receiving portion 330C of the first optical sensor 330 is the ON state and the state of the light-receiving portion 332C of the second optical sensor 332 is the ON state in S1.

When the control unit 400 determines that the condition that the state of the light-receiving portion 330C of the first optical sensor 330 is the ON state and the state of the light-receiving portion 332C of the second optical sensor 332 is the ON state is not satisfied in S1, the control unit 400 determines whether or not the state of the light-receiving portion 330C of the first optical sensor 330 is the OFF state and the state of the light-receiving portion 332C of the second optical sensor 332 is the ON state in S2.

The fact that the light-receiving portion 330C is in the OFF state and the light-receiving portion 332C is in the ON state means that the position of the ink surface L in the ink chamber 11 is higher than the ink surface position. Therefore, when the control unit 400 determines that the state of the light-receiving portion 330C of the first optical sensor 330 is the OFF state and the state of the light-receiving portion 332C of the second optical sensor 332 is the ON state in S2, the control unit 400 determines that the remaining amount of ink in the ink chamber 11 is an amount which makes the position of the ink surface L higher than the second ink surface position, and causes the display portion 340 to display the determined remaining amount on the remaining amount display portion 340A of the display portion 340 in S3. More specifically, the remaining amount display portion 340A displays the remaining amount of ink as shown in FIG. 21(A). Thereafter, the control unit 400 causes the light-emitting portion 330B of the first optical sensor 330 and the light-emitting portion 332B of the second optical sensor 332 to stop emission of the light.

Then, the control unit 400 causes the light-emitting portion 330B of the first optical sensor 330 and the light-emitting portion 332B of the second optical sensor 332 to emit the light and whether or not the state of the light-receiving portion 330C of the first optical sensor 330 is the OFF state and the state of the light-receiving portion 332C of the second optical sensor 332 is the ON state is determined in S4. When the control unit 400 determines that the state of the light-receiving portion 330C of the first optical sensor 330 is the OFF state and the state of the light-receiving portion 332C of the second optical sensor 332 is the ON state, the control unit 400 repeats S4 periodically.

When the control unit 400 determines that the condition that the state of the light-receiving portion 330C of the first optical sensor 330 is the OFF state and the state of the light-receiving portion 332C of the second optical sensor 332 is the ON state is not satisfied in S4, the control unit 400 determines whether or not the state of the light-receiving portion 330C of the first optical sensor 330 is the OFF state and the state of the light-receiving portion 332C of the second optical sensor 332 is the OFF state in S5.

The fact that the light-receiving portion 330C is in the OFF state and the light-receiving portion 332C is in the OFF state means that the position of the ink surface L in the ink chamber 11 has reached the second ink surface position. Therefore, when the control unit 400 determines that the state of the light-receiving portion 330C of the first optical sensor 330 is the OFF state and the state of the light-receiving portion 332C of the second optical sensor 332 is the OFF state in S5, the control unit 400 determines that the remaining amount of ink in the ink chamber 11 is an amount which makes the position of the ink surface L to be equal to the second ink surface position, and causes the display portion 340 to display the determined remaining amount on the remaining amount display portion 340A of the display portion 340 in S6. More specifically, the remaining amount display portion 340A displays the remaining amount of ink as shown in FIG. 21(B). Thereafter, the control unit 400 causes the light-emitting portion 330B of the first optical sensor 330 and the light-emitting portion 332B of the second optical sensor 332 to stop emission of the light.

Then, the control unit 400 causes the light-emitting portion 330B of the first optical sensor 330 and the light-emitting portion 332B of the second optical sensor 332 to emit the light and whether or not the state of the light-receiving portion 330C of the first optical sensor 330 is the OFF state and the state of the light-receiving portion 332C of the second optical sensor 332 is the OFF state is determined in S7. When the control unit 400 determines that the state of the light-receiving portion 330C of the first optical sensor 330 is the OFF state and the state of the light-receiving portion 332C of the second optical sensor 332 is the OFF state, the control unit 400 repeats S7 periodically.

When the control unit 400 determines that the condition that the state of the light-receiving portion 330C of the first optical sensor 330 is the OFF state and the state of the light-receiving portion 332C of the second optical sensor 332 is the OFF state is not satisfied in S7, the control unit 400 determines whether or not the state of the light-receiving portion 330C of the first optical sensor 330 is the ON state and the state of the light-receiving portion 332C of the second optical sensor 332 is the OFF state in S8.

The fact that the light-receiving portion 330C is in the ON state and the light-receiving portion 332C is in the OFF state means that the position of the surface L in the ink chamber 11 has reached the third ink surface position. Therefore, when the control unit 400 determines that the state of the light-receiving portion 330C of the first optical sensor 330 is the ON state and the state of the light-receiving portion 332C of the second optical sensor 332 is the OFF state in S8, the control unit 400 determines that the remaining amount of ink in the ink chamber 11 is an amount which makes the position of the ink surface L to be equal to the third ink surface position, and causes the display portion 340 to display the determined remaining amount on the remaining amount display portion 340A of the display portion 340 in S9. More specifically, the remaining amount display portion 340A displays the remaining amount of ink as shown in FIG. 21(C). Thereafter, the control unit 400 causes the light-emitting portion 330B of the first optical sensor 330 and the light-emitting portion 332B of the second optical sensor 332 to stop emission of the light.

Then, the control unit 400 causes the light-emitting portion 330B of the first optical sensor 330 and the light-emitting portion 332B of the second optical sensor 332 to emit the light and whether or not the state of the light-receiving portion 330C of the first optical sensor 330 is the ON state and the state of the light-receiving portion 332C of the second optical sensor 332 is the OFF state is determined in S10. When the control unit 400 determines that the state of the light-receiving portion 330C of the first optical sensor 330 is the ON state and the state of the light-receiving portion 332C of the second optical sensor 332 is the OFF state, the control unit 400 repeats S10 periodically.

When the control unit 400 determines that the condition that the state of the light-receiving portion 330C of the first optical sensor 330 is the ON state and the state of the light-receiving portion 332C of the second optical sensor 332 is the OFF state is not satisfied in S10, it means that the state of the light-receiving portion 330C of the first optical sensor 330 is the ON state and the state of the light-receiving portion 332C of the second optical sensor 332 is the ON state. Then, the fact that the light-receiving portion 332C is in the ON state and the light-receiving portion 330C is in the ON state means that the position of the ink surface L in the ink chamber 11 has reached the fourth ink surface position. Therefore, when the control unit 400 determines that the condition that the state of the light-receiving portion 330C of the first optical sensor 330 is the ON state and the state of the light-receiving portion 332C of the second optical sensor 332 is the OFF state is not satisfied in S10, the control unit 400 determines that the remaining amount of ink in the ink chamber 11 is an amount which makes the position of the ink surface L to be equal to the fourth ink surface position, and causes the display portion 340 to display the determined remaining amount on the remaining amount display portion 340A of the display portion 340 in S11. More specifically, the remaining amount display portion 340A displays the remaining amount of ink as shown in FIG. 21(D). The control unit 400 also causes the display portion 340 to display a predetermined message to notify the user that the remaining amount of ink in the ink cartridge 10 is small. Thereafter, the control unit 400 causes the light-emitting portion 330B of the first optical sensor 330 and the light-emitting portion 332B of the second optical sensor 332 to stop emission of the light.

Then, the control unit 400 starts to count the number of times of ink discharge by the printhead 132 in S12. Then, in S13, whether or not the number of times of ink discharge by the printhead 132 exceeds the predetermined number of times is determined. When the control unit 400 determines that the number of times of ink discharge by the printhead 132 does not exceed the predetermined number of times, S13 is repeated periodically.

When it is determined that the number of times of ink discharge by the printhead 132 exceeds the predetermined number of times in S13, the control unit 400 causes the remaining amount display portion 340A of the display portion 340 to display a message saying the ink chamber 11 is empty in S14. More specifically, the remaining amount display portion 340A displays the remaining amount of ink as shown in FIG. 21(E). The control unit 400, for example, causes the display portion 340 to display the predetermined message to urge the user to replace the ink cartridge 10 with a new one, and ends the determination process shown in the flowcharts in FIG. 17 to FIG. 20.

When the control unit 400 determines that the state of the light-receiving portion 330C of the first optical sensor 330 is the ON state and the state of the light-receiving portion 332C of the second optical sensor 332 is the ON state in S1, it means that the position of the ink surface L in the ink chamber 11 of the ink cartridge 10 mounted to the mounting portion 300 is lower than or equal to the fourth ink surface position. In this case, it may be considered that the ink chamber 11 is empty. Therefore, when the control unit 400 determines that the state of the light-receiving portion 330C of the first optical sensor 330 is the ON state and the state of the light-receiving portion 332C of the second optical sensor 332 is the ON state in S1, the control unit 400 causes the remaining amount display portion 340A of the display portion 340 to display the message saying that the ink chamber 11 is empty in S15. More specifically, the remaining amount display portion 340A displays the remaining amount of ink as shown in FIG. 21(E). The control unit 400, for example, causes the display portion 340 to display the predetermined message to urge the user to replace the ink cartridge 10 with a new one, and ends the determination process shown in the flowcharts in FIG. 17 to FIG. 20.

In S2, when the control unit 400 determines that the condition that the state of the light-receiving portion 330C of the first optical sensor 330 is the OFF state and the state of the light-receiving portion 332C of the second optical sensor 332 is the ON state is not satisfied, the procedure goes to S5.

When the control unit 400 determines that the condition that the state of the light-receiving portion 330C of the first optical sensor 330 is the OFF state and the state of the light-receiving portion 332C of the second optical sensor 332 is the OFF state is not satisfied in S5, the control unit 400 determines whether or not the state of the light-receiving portion 330C of the first optical sensor 330 is the ON state and the state of the light-receiving portion 332C of the second optical sensor 332 is the OFF state in S16. In S16, when the control unit 400 determines that the state of the light-receiving portion 330C of the first optical sensor 330 is the ON state and the state of the light-receiving portion 332C of the second optical sensor 332 is the OFF state, the procedure goes to S9. In S16, when the control unit 400 determines that the condition that the state of the light-receiving portion 330C of the first optical sensor 330 is the ON state and the state of the light-receiving portion 332C of the second optical sensor 332 is the OFF state is not satisfied, the procedure goes to S11.

In S8, when the control unit 400 determines that the condition that the state of the light-receiving portion 330C of the first optical sensor 330 is the ON state and the state of the light-receiving portion 332C of the second optical sensor 332 is the OFF state is not satisfied, the procedure goes to S11.

The control unit 400 may cause the light-emitting portion 330B and the light-emitting portion 332B to always emit the light, or may cause the light-emitting portion 330B and the light-emitting portion 332B to emit the light only when the states of the light-receiving portion 330C and the light-receiving portion 332C are determined during the determination process shown in the flowcharts in FIG. 17 to FIG. 20.

In this manner, the ink discharging system 1 as an example of the ink surface detecting system in the present invention detects the ink surface in the ink chamber 11 in multiple steps and displays the remaining amount of ink on the remaining amount display portion 340A on the basis of the result.

In this embodiment, for example, the four ink cartridges 10 are mounted respectively to the four mounting portions 300. The determination process shown in the flowcharts in FIG. 17 to FIG. 20 is performed for each of the four ink cartridges 10.

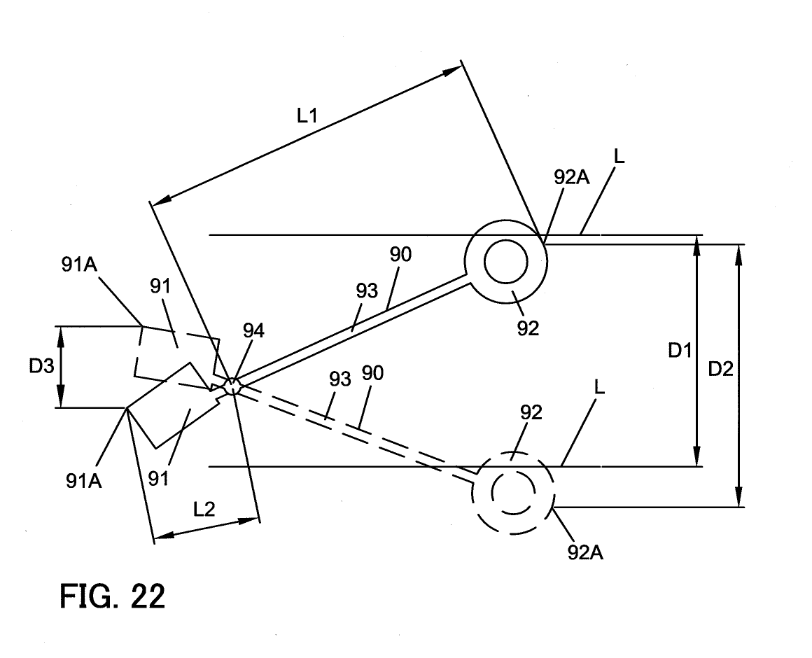

FIG. 22 shows the pivoting member 90 and the ink surface L extracted from FIG. 13 and FIG. 16 and superimposed one on top of another. For the sake of convenience, hatching is omitted, and the pivoting member 90 extracted from FIG. 16 is shown by a broken line In FIG. 22.

Referring to FIG. 22, the floating portion 92 comprises a first end 92A positioned farthest from the center of pivotal movement in the floating portion 92, and the detected portion 91 comprises a second end 91A positioned farthest from the center of pivotal movement of the detected portion 91 in the detected portion 91. A first distance L1 between the center of pivotal movement and the first end 92A is greater than a second distance L2 between the center of pivotal movement and the second end 91A. Therefore, when a distance D2 the first end 92A moves in the vertical direction and a distance D3 the second end 91A moves in the vertical direction when the ink surface L moves from the first ink surface position to the fourth ink surface position are compared, the distance D2 of the first end 92A is almost the same as a distance D1 between the first ink surface position and the fourth ink surface position, while the distance D3 of the second end 91A is less than the distance D1 between the first ink surface position and the fourth ink surface position. Therefore, even when the ink discharging system 1 is made to detect the first ink surface position and the fourth ink surface position, the first optical sensor 330 and the second optical sensor 332 can be positioned closer to each other than the distance between the ink surface positions in the vertical direction. As is so in this embodiment, when the first optical sensor 330 and the second optical sensor 332 are needed to be positioned in a small space between the ink supply tube 320 and the atmospheric air introduction tube 325 in the vertical direction, it is advantageous that the first optical sensor 330 and the second optical sensor 332 can be positioned close to each other in the vertical direction.

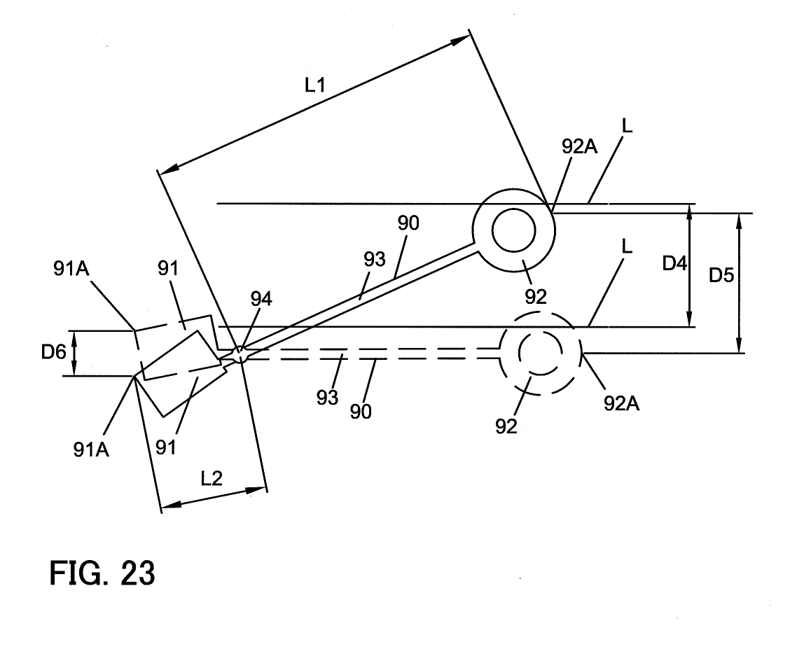

FIG. 23 shows the pivoting member 90 and the ink surface L extracted from FIG. 13 and FIG. 15 and superimposed one on top of another. For the sake of convenience, hatching is omitted, and the pivoting member 90 extracted from FIG. 15 is shown by the broken line in FIG. 23.

The first distance L1 between the center of pivotal movement and the first end 92A is greater than the second distance L2 between the center of pivotal movement and the second end 91A. Therefore, as shown in FIG. 23, when a distance D5 the first end 92A moves in the vertical direction and a distance D6 the second end 91A moves in the vertical direction when the ink surface L moves from the first ink surface position to the third ink surface position are compared, the distance D5 of the first end 92A is almost the same as a distance D4 between the first ink surface position and the third ink surface position, while the distance D6 of the second end 91A is less than the distance D4 between the first ink surface position and the third ink surface position. Therefore, even when the ink discharging system 1 is made to detect the first ink surface position and the third ink surface position, the first optical sensor 330 and the second optical sensor 332 can be positioned closer to each other than the distance between the ink surface positions in the vertical direction. As is so in this embodiment, when the first optical sensor 330 and the second optical sensor 332 are needed to be positioned in the small space between the ink supply tube 320 and the atmospheric air introduction tube 325 in the vertical direction, it is advantageous that the first optical sensor 330 and the second optical sensor 332 can be positioned close to each other in the vertical direction.

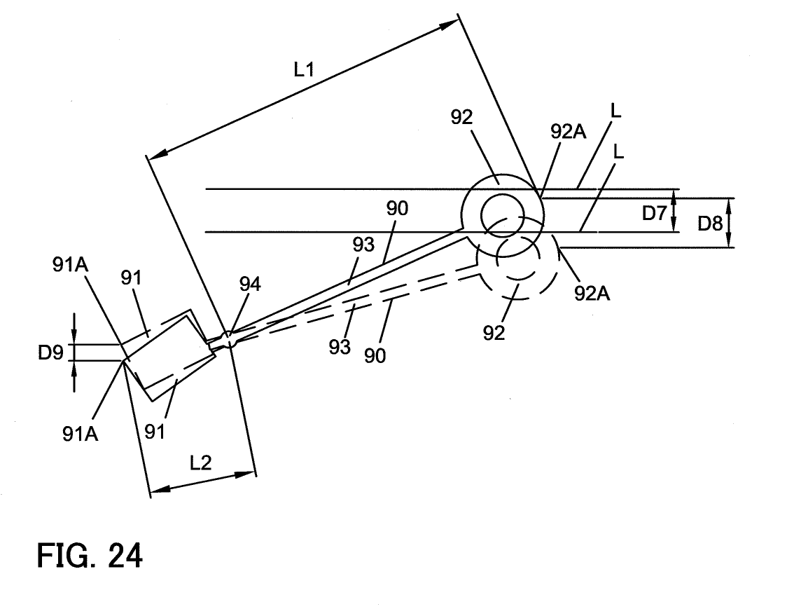

FIG. 24 shows the pivoting member 90 and the ink surface L extracted from FIG. 13 and FIG. 14 and superimposed one on top of another. For the sake of convenience, hatching is omitted, and the pivoting member 90 extracted from FIG. 14 is shown by the broken line in FIG. 24.

The first distance L1 between the center of pivotal movement and the first end 92A is greater than the second distance L2 between the center of pivotal movement and the second end 91A. Therefore, as shown in FIG. 24, when a distance D8 the first end 92A moves in the vertical direction and a distance D9 the second end 91A moves in the vertical direction when the ink surface L moves from the first ink surface position to the second ink surface position in the vertical direction are compared, the distance D8 of the first end 92A is almost the same as a distance D7 between the first ink surface position and the second ink surface position, while the distance D9 of the second end 91A is less than the distance D7 between the first ink surface position and the second ink surface position. Therefore, even when the ink discharging system 1 is made to detect the first ink surface position and the second ink surface position, the first optical sensor 330 and the second optical sensor 332 can be positioned closer to each other than the distance between the ink surface positions in the vertical direction. As is so in this embodiment, when the first optical sensor 330 and the second optical sensor 332 are needed to be positioned in the small space between the ink supply tube 320 and the atmospheric air introduction tube 325 in the vertical direction, it is advantageous that the first optical sensor 330 and the second optical sensor 332 can be positioned close to each other in the vertical direction.

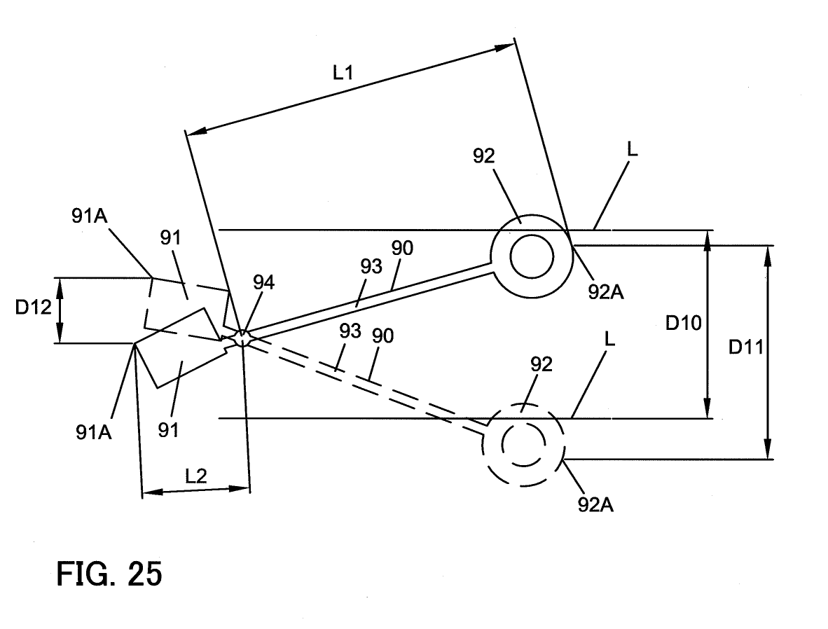

FIG. 25 shows the pivoting member 90 and the ink surface L extracted from FIG. 14 and FIG. 16 and superimposed one on top of another. For the sake of convenience, hatching is omitted, and the pivoting member 90 extracted from FIG. 16 is shown by the broken line in FIG. 25.

The first distance L1 between the center of pivotal movement and the first end 92A is greater than the second distance L2 between the center of pivotal movement and the second end 91A. Therefore, as shown in FIG. 25, when a distance D11 the first end 92A moves in the vertical direction and a distance D12 the second end 91A moves in the vertical direction when the ink surface L moves from the second ink surface position to the fourth ink surface position are compared, the distance D11 of the first end 92A is almost the same as a distance D10 between the second ink surface position and the fourth ink surface position, while the distance D12 of the second end 91A is less than the distance D10 between the second ink surface position and the fourth ink surface position. Therefore, even when the ink discharging system 1 is made to detect the second ink surface position and the fourth ink surface position, the first optical sensor 330 and the second optical sensor 332 can be positioned close to each other than the distance between the ink surface positions in the vertical direction. As is so in this embodiment, when the first optical sensor 330 and the second optical sensor 332 are needed to be positioned in the small space between the ink supply tube 320 and the atmospheric air introduction tube 325 in the vertical direction, it is advantageous that the first optical sensor 330 and the second optical sensor 332 can be positioned close to each other in the vertical direction.

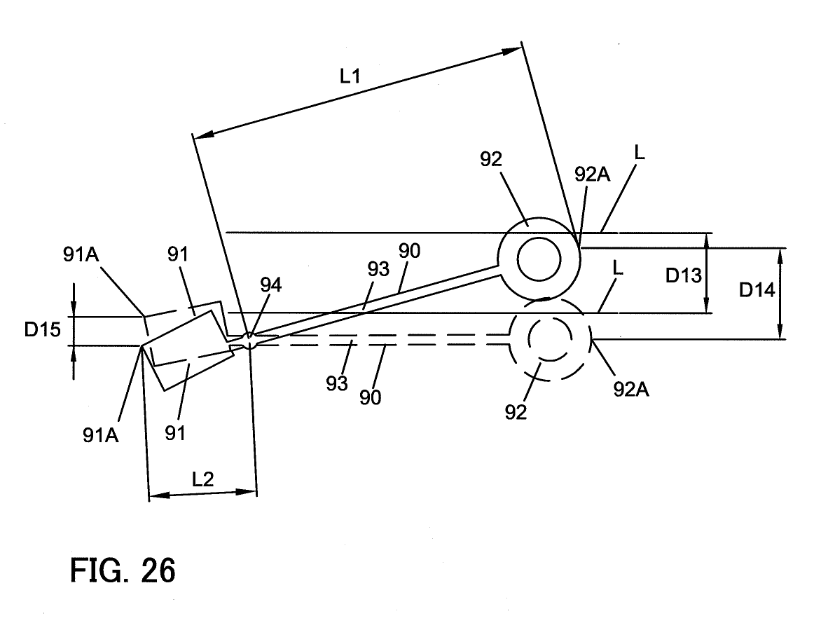

FIG. 26 shows the pivoting member 90 and the ink surface L extracted from FIG. 14 and FIG. 15 and superimposed one on top of another. For the sake of convenience, hatching is omitted, and the pivoting member 90 extracted from FIG. 15 is shown by the broken line in FIG. 26.

The first distance L1 between the center of pivotal movement and the first end 92A is greater than the second distance L2 between the center of pivotal movement and the second end 91A. Therefore, as shown in FIG. 26, when a distance D14 the first end 92A moves in the vertical direction and a distance D15 the second end 91A moves in the vertical direction when the ink surface L moves from the second ink surface position to the third ink surface position are compared, the distance D14 of the first end 92A is almost the same as a distance D13 between the second ink surface position and the third ink surface position, while the distance D15 of the second end 91A is less than the distance D13 between the second ink surface position and the third ink surface position. Therefore, even when the ink discharging system 1 is made to detect the second ink surface position and the third ink surface position, the first optical sensor 330 and the second optical sensor 332 can be positioned closer to each other than the distance between the ink surface positions in the vertical direction. As is so in this embodiment, when the first optical sensor 330 and the second optical sensor 332 are needed to be positioned in the small space between the ink supply tube 320 and the atmospheric air introduction tube 325 in the vertical direction, it is advantageous that the first optical sensor 330 and the second optical sensor 332 can be positioned close to each other in the vertical direction.

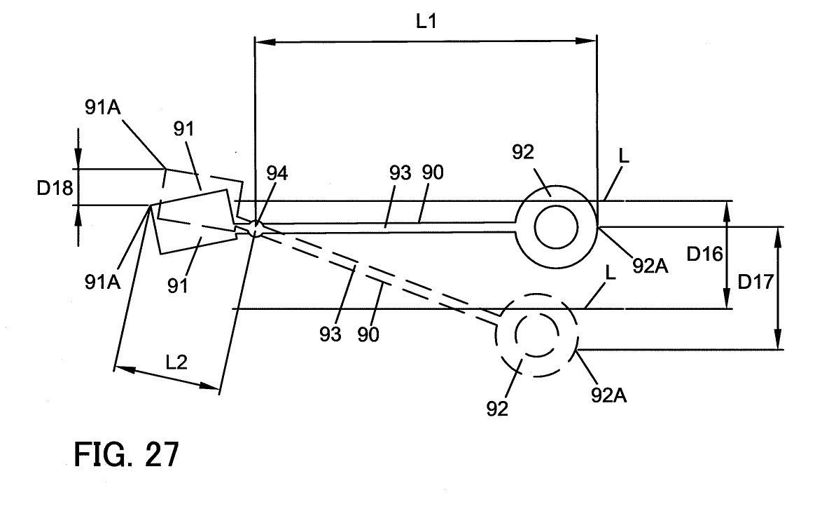

FIG. 27 shows the pivoting member 90 and the ink surface L extracted from FIG. 15 and FIG. 16 and superimposed one on top of another. For the sake of convenience, hatching is omitted, and the pivoting member 90 extracted from FIG. 16 is shown by the broken line in FIG. 27.

The first distance L1 between the center of pivotal movement and the first end 92A is greater than the second distance L2 between the center of pivotal movement and the second end 91A. Therefore, as shown in FIG. 27, when a distance D17 the first end 92A moves in the vertical direction and a distance D18 the second end 91A moves in the vertical direction when the ink surface L moves from the third ink surface position to the fourth ink surface position in the vertical direction are compared, the distance D17 of the first end 92A is almost the same as a distance D16 between the third ink surface position and the fourth ink surface position, while the distance D18 the second end 91A moves is less than the distance D16 between the third ink surface position and the fourth ink surface position. Therefore, even when the ink discharging system 1 is made to detect the third ink surface position and the fourth ink surface position, the first optical sensor 330 and the second optical sensor 332 can be positioned closer to each other than the distance between the ink surface positions in the vertical direction. As is so in this embodiment, when the first optical sensor 330 and the second optical sensor 332 are needed to be positioned in the small space between the ink supply tube 320 and the atmospheric air introduction tube 325 in the vertical direction, it is advantageous that the first optical sensor 330 and the second optical sensor 332 can be positioned close to each other in the vertical direction.

In this embodiment, the floating portion 92 comprises a cavity in the interior thereof. However, when the pivoting member 90 is formed of a material having a specific gravity smaller than that of the ink stored in the ink chamber 11, the interior of the floating portion 92 may not have the cavity.

In this embodiment, the detected portion 91 prevents the light emitted from the light-emitting portion 330B and the light-emitting portion 332B from passing therethrough. However, the detected portion may be configured to alter a path of the light emitted from the light-emitting portion 330B and the light-emitting portion 332B. For example, it may be configured in such a manner that aluminum foil is deposited on the detected portion, and the detected portion reflects the light emitted from the light-emitting portions 330B and 332B. Alternatively, the detected portion may be configured to alter a path of at least a portion of the light.

In this embodiment, the light-receiving portion 330C and the light-receiving portion 332C are each configured to receive the light when the detected portion 91 does not block the light emitted from the light-emitting portion 330B and the light-emitting portion 332B. However, in a case where the detected portion is configured to reflect the light emitted from the light-emitting portion, the light-receiving portion may be configured to receive the reflected light when the light emitted from the light-emitting portion is reflected by the detected portion.

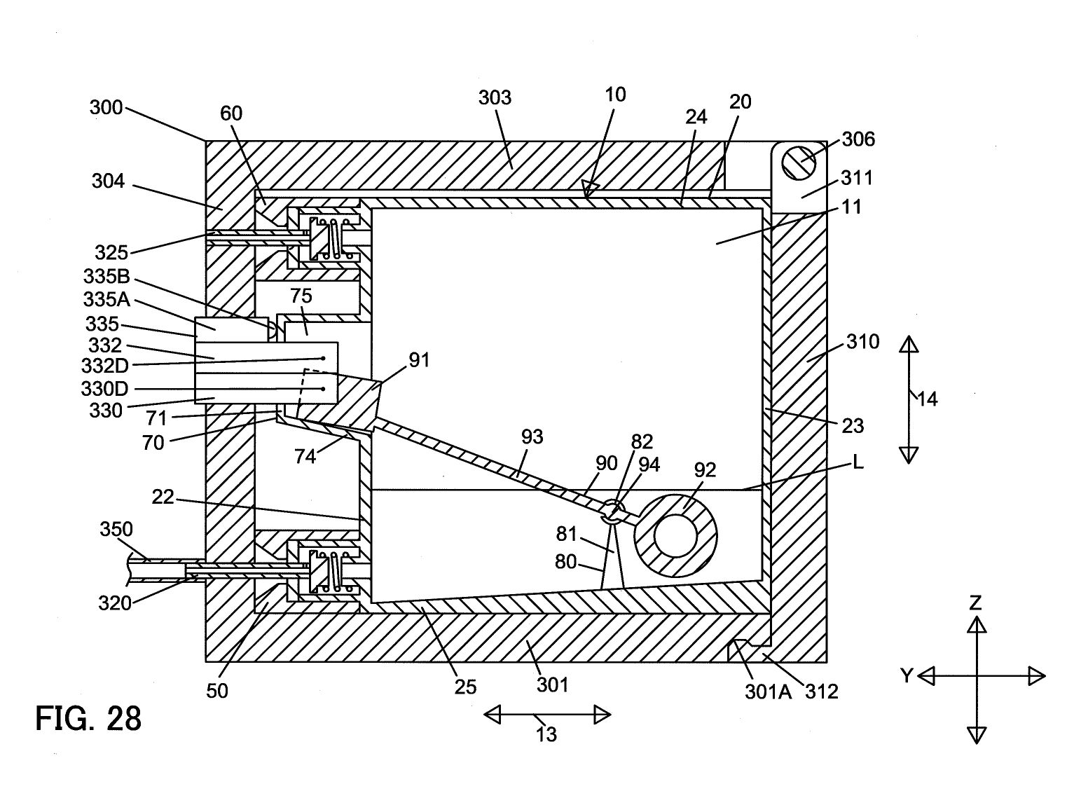

Referring to FIG. 28 to FIG. 38, the ink discharging system 1 as a second embodiment of the present invention is described. Because the second embodiment is different from the first embodiment only in shape and arrangement of elements of the ink cartridge 10 and the mounting portion 300, the same reference numerals as the first embodiment are used for the description of the second embodiment. Descriptions of the same elements as those in the first embodiment are omitted. Only elements which are different from those in the first embodiment are described.

Referring to FIG. 28, the dimension of the protrusion 70 of the ink cartridge 10 of the second embodiment is less than the dimension of the protrusion 70 of the first embodiment in the heightwise direction 14. Moreover, the first optical sensor 330, the second optical sensor 332, and the limit switch 335 of the second embodiment are positioned closer to each other in comparison with the first optical sensor 330, the second optical sensor 332, and the limit switch 335 of the first embodiment, corresponding to the dimension of the protrusion 70 in the heightwise direction 14.

The shaft 94 of the pivoting member 90 of the first embodiment is positioned closer to the detected portion 91 than to the floating portion 92, while the shaft 94 of the pivoting member 90 of the second embodiment is positioned closer to the floating portion 92 than to the detected portion 91.

The distance between the pair of supporting members 80 and the front wall 22 is less than the distance between the pair of supporting members 80 and the back wall 23 in the first embodiment, while the distance between the pair of supporting members 80 and the front wall 22 is greater than the distance between the pair of supporting members 80 and the back wall 23 in the second embodiment. When the ink cartridge 10 is mounted to the mounting portion 300, the supporting portion 82 of the second embodiment is positioned below the protrusion 70.

Referring to FIG. 28 to FIG. 31, the movement of the pivoting member 90 according to the lowering of the ink surface in the ink chamber 11 is described.

An initial amount of the ink stored in the ink chamber 11 of the ink cartridge 10 in the second embodiment is less than that in the first embodiment. The ink cartridge 10 having a small initial amount of ink as such may be suitable for the users using the ink jet printer 100 occasionally. When the ink cartridge 10 is left unused for a long time in the mounting portion 300 in a state in which the ink chamber 11 is in communication with the atmospheric air via the atmospheric air introduction valve mechanism 60, components of the ink in the ink chamber 11 may be oxidized or evaporated, such that the ink is degraded. When the user who uses the ink-jet printer 100 occasionally uses the ink cartridge 10 with a large initial amount of ink, a period in which the ink cartridge 10 is left unused in the mounting portion 300 in a state in which the ink chamber 11 is in communication with the atmospheric air via the atmospheric air introduction valve mechanism 60 becomes longer. Therefore, it might be better for the user who uses the ink-jet printer 100 occasionally to use the ink cartridge 10 with a small initial amount of ink to use up a needed amount of ink at one time.

In a state in which the ink cartridge 10 is mounted to the mounting portion 300, the ink surface L in the ink chamber 11 is positioned as shown in FIG. 28. As shown in FIG. 28, the floating portion 92 is positioned under the ink surface L, while the detected portion 91 is positioned above the ink surface L. The floating portion 92 attempts to approach the ink surface L in the ink chamber 11. When the floating portion 92 attempts to approach the ink surface L, the pivoting member 90 attempts to move counterclockwise in FIG. 28. However, because the detected portion 91 is in contact with the bottom wall 74, the movement of the pivoting member 90 is prevented, and the pivoting member 90 maintains a position in which the detected portion 91 is in contact with the bottom wall 74. At this state, the floating portion 92 is positioned lower than the first optical sensor 330 and the second optical sensor 332. Because the detected portion 91 interests the optical path 330D of the first optical sensor 330, and when the light is emitted from the light-emitting portion 330B, the detected portion 91 blocks the light. In other words, when the light is emitted from the light-emitting portion 330B, the light-receiving portion 330C is determined to be in the OFF state. In contrast, because the detected portion 91 does not intersect the optical path 332D of the second optical sensor 332, when the light is emitted from the light-emitting portion 332B, the light passes through the pair of side walls 72 of the protrusion 70 and reaches the light-receiving portion 332C. In other words, when the light is emitted from the light-emitting portion 332B, the light-receiving portion 332C is determined to be in the ON state.

When the printhead 132 discharges ink onto a sheet of printing paper, ink is supplied from the ink chamber 11 to the sub tank 135 accordingly. When ink in the ink chamber 11 is consumed, the ink surface L in the ink chamber 11 is lowered.

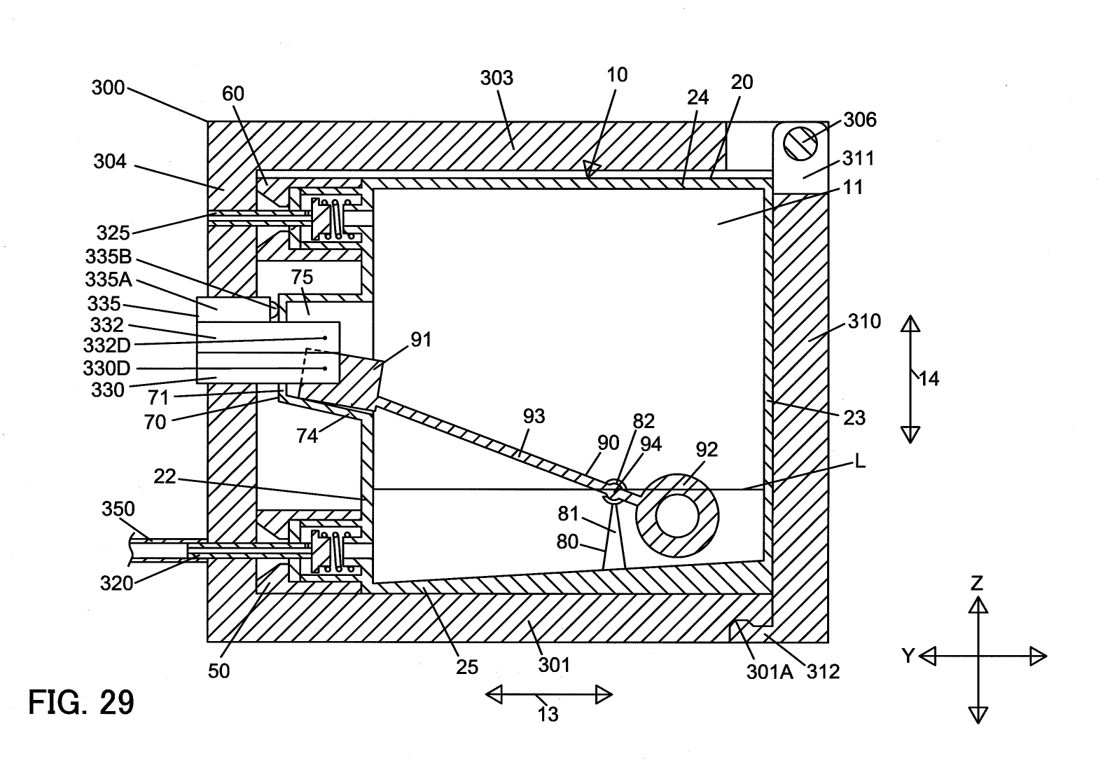

When ink is supplied from the ink chamber 11 to the sub tank 135, and the ink surface L in the ink chamber 11 reaches the fifth ink surface position, a portion of the floating portion 92 of the pivoting member 90 is exposed in the air in the ink chamber 11 from the ink surface L as shown in FIG. 29, and the gravity and the buoyancy acting on the floating portion 92 becomes equal. The fifth ink surface position is lower than the first optical sensor 330 and the second optical sensor 332. Also, when the ink surface L is at the fifth ink surface position, the floating portion 92 is positioned lower than the first optical sensor 330 and the second optical sensor 332.

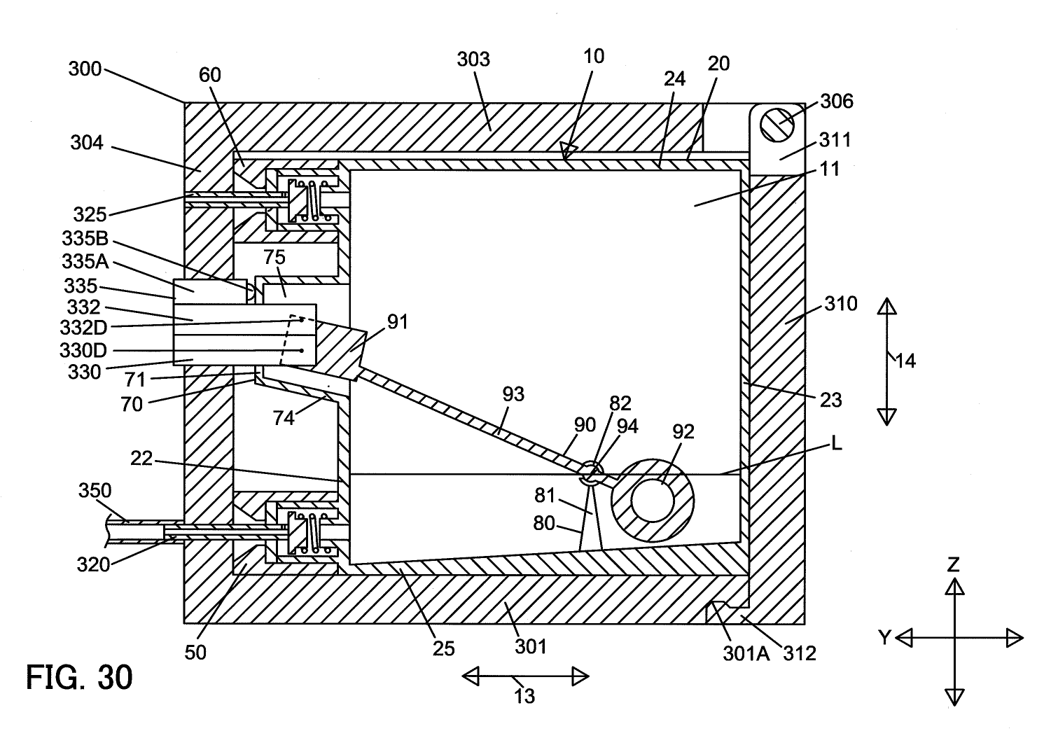

When ink is further supplied from the ink chamber 11 to the sub tank 135, the pivoting member 90 moves clockwise in FIG. 29 in association with the lowering of the ink surface L. As shown in FIG. 30, when the ink surface L reaches the sixth ink surface position, the detected portion 91 intersects the optical path 330D of the first optical sensor 330, and also intersects the optical path 332D of the second optical sensor 332. At this state, when the light is emitted from the light-emitting portion 330B of the first optical sensor 330, the detected portion 91 blocks the light. In other words, when the light is emitted from the light-emitting portion 330B, the light-receiving portion 330C is determined to be in the OFF state. Also, when the light is emitted from the light-emitting portion 332B of the second optical sensor 332, the detected portion 91 blocks the light. In other words, when the light is emitted from the light-emitting portion 332B, the light-receiving portion 332C is determined to be in the OFF state. The sixth ink surface position is lower than the first optical sensor 330 and the second optical sensor 332. Also, when the ink surface L is at the sixth ink surface position, the floating portion 92 is positioned lower than the first optical sensor 330 and the second optical sensor 332.

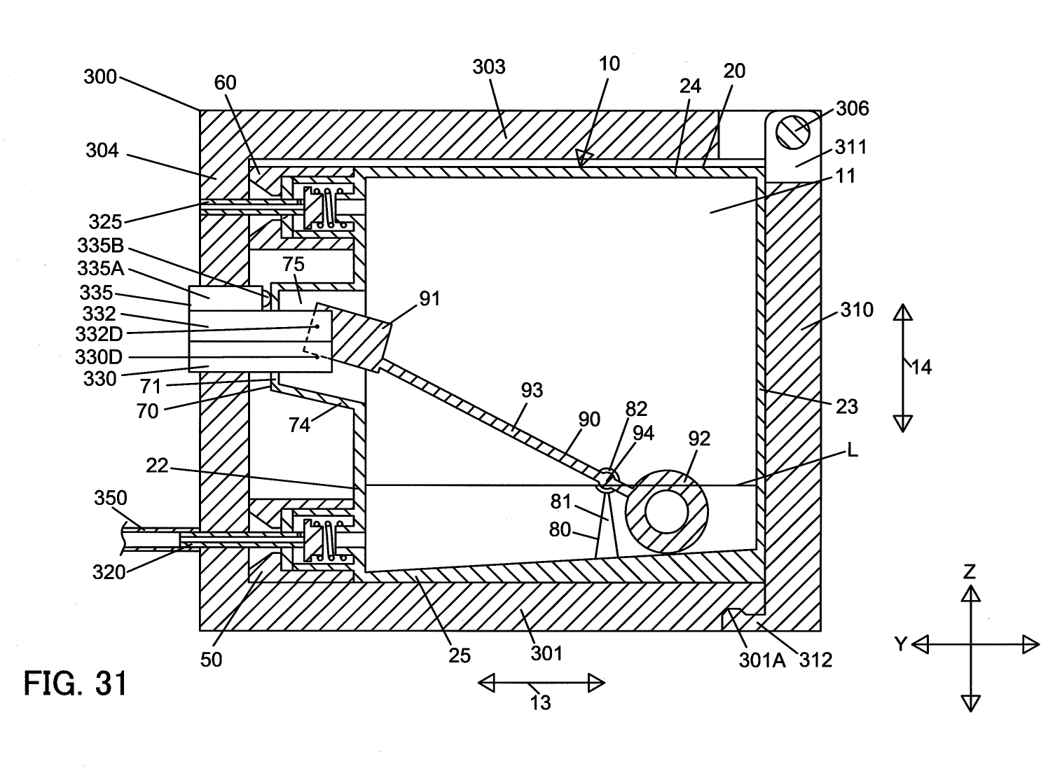

When ink is further supplied from the ink chamber 11 to the sub tank 135, the pivoting member 90 moves clockwise in FIG. 30 in association with the lowering of the ink surface L. As shown in FIG. 31, when the ink surface L reaches the seventh ink surface position, the detected portion 91 does not intersect the optical path 330D of the first optical sensor 330, but intersects the optical path 332D of the second optical sensor 332. At this state, when the light is emitted from the light-emitting portion 330B of the first optical sensor 330, the light passes through the pair of side walls 72 of the protrusion 70 and reaches the light-receiving portion 330C. In other words, when the light is emitted from the light-emitting portion 330B, the light-receiving portion 330C is determined to be in the ON state. On the other hand, when the light is emitted from the light-emitting portion 332B of the second optical sensor 332, the detected portion 91 blocks the light. In other words, when the light is emitted from the light-emitting portion 332B, the light-receiving portion 332C is determined to be in the OFF state. The seventh ink surface position is lower than the first optical sensor 330 and the second optical sensor 332. Also, when the ink surface L is at the seventh ink surface position, the floating portion 92 is positioned lower than the first optical sensor 330 and the second optical sensor 332.

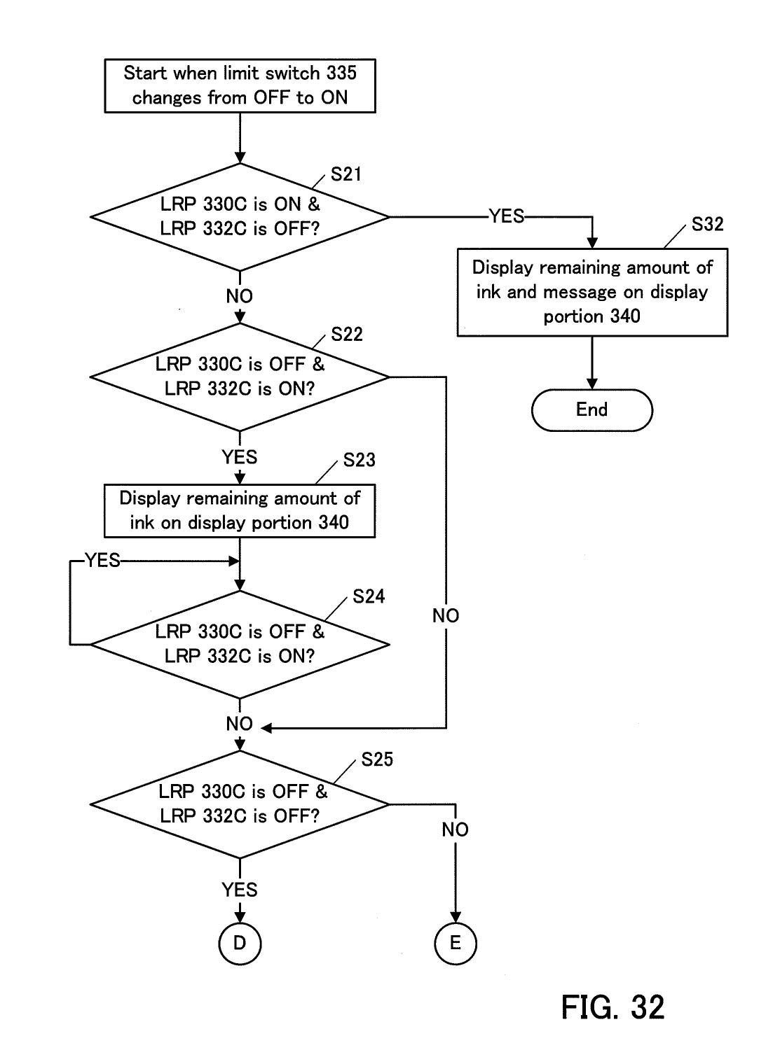

The control unit 400 monitors the state of the limit switch 335 and starts the determination process of FIG. 32 to FIG. 34 when the state of the limit switch 335 is changed from the OFF state to the ON state. In other words, the determination process of FIG. 32 to FIG. 34 is started when the fact that the ink cartridge 10 is mounted to the mounting portion 300 is detected.

When the determination process is started, the control unit 400 causes the light-emitting portion 330B of the first optical sensor 330 and the light-emitting portion 33213 of the second optical sensor 332 to emit light and determines whether or not the state of the light-receiving portion 330C of the first optical sensor 330 is the ON state and the state of the light-receiving portion 332C of the second optical sensor 332 is the OFF state in S21.

When the control unit 400 determines that the condition that the state of the light-receiving portion 330C of the first optical sensor 330 is the ON state and the state of the light-receiving portion 332C of the second optical sensor 332 is the OFF state is not satisfied in S21, the control unit 400 determines whether or not the state of the light-receiving portion 330C of the first optical sensor 330 is the OFF state and the state of the light-receiving portion 332C of the second optical sensor 332 is the ON state in S22.

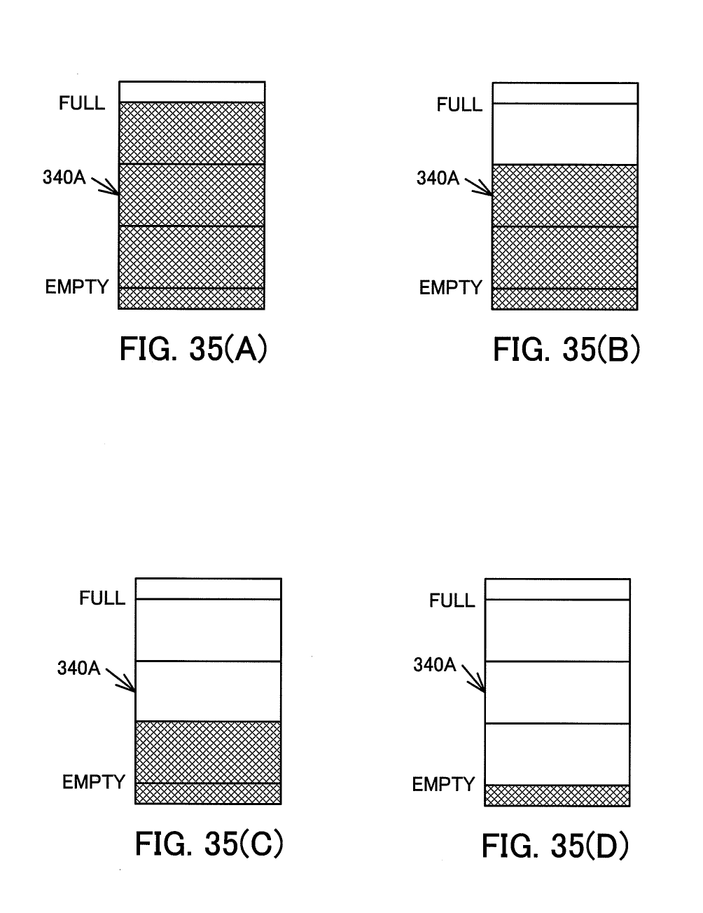

The fact that the light-receiving portion 330C is in the OFF state and the light-receiving portion 332C is in the ON state means that the position of the ink surface L in the ink chamber 11 is higher than the sixth ink surface position. Therefore, if the control unit 400 determines that the state of the light-receiving portion 330C of the first optical sensor 330 is the OFF state and the state of the light-receiving portion 332C of the second optical sensor 332 is the ON state in S22, the control unit 400 determines that the remaining amount of ink in the ink chamber 11 is an amount which makes the position of the ink surface L to be higher than the sixth ink surface position, and causes the display portion 340 to display the determined remaining amount on the remaining amount display portion 340A of the display portion 340 in S23. More specifically, the remaining amount display portion 340A displays the remaining amount of ink as shown in FIG. 35(A). Thereafter, the control unit 400 causes the light-emitting portion 330B of the first optical sensor 330 and the light-emitting portion 332B of the second optical sensor 332 to stop emission of the light.

Then, the control unit 400 causes the light-emitting portion 330B of the first optical sensor 330 and the light-emitting portion 332B of the second optical sensor 332 to emit light and whether or not the state of the light-receiving portion 330C of the first optical sensor 330 is the OFF state and the state of the light-receiving portion 332C of the second optical sensor 332 is the ON state is determined in S24. When the control unit 400 determines that the state of the light-receiving portion 330C of the first optical sensor 330 is the OFF state and the state of the light-receiving portion 332C of the second optical sensor 332 is the ON state, the control unit 400 repeats S24 periodically.

When the control unit 400 determines that the condition that the state of the light-receiving portion 330C of the first optical sensor 330 is the OFF state and the state of the light-receiving portion 332C of the second optical sensor 332 is the ON state is not satisfied in S24, the control unit 400 determines whether or not the state of the light-receiving portion 330C of the first optical sensor 330 is the OFF state and the state of the light-receiving portion 332C of the second optical sensor 332 is the OFF state in S25.

The fact that the light-receiving portion 330C is in the OFF state and the light-receiving portion 332C is in the OFF state means that the position of the ink surface L in the ink chamber 11 has reached the sixth ink surface position. Therefore, when the control unit 400 determines that the state of the light-receiving portion 330C of the first optical sensor 330 is the OFF state and the state of the light-receiving portion 332C of the second optical sensor 332 is the OFF state in S25, the control unit 400 determines that the remaining amount of ink in the ink chamber 11 is an amount which makes the position of the ink surface L to be equal to the sixth ink surface position, and causes the display portion 340 to display the remaining amount on the remaining amount display portion 340A of the display portion 340 in S26. More specifically, the remaining amount display portion 340A displays the remaining amount of ink as shown in FIG. 35(B). Thereafter, the control unit 400 causes the light-emitting portion 33013 of the first optical sensor 330 and the light-emitting portion 332B of the second optical sensor 332 to stop emission of the light.

Then, the control unit 400 causes the light-emitting portion 330B of the first optical sensor 330 and the light-emitting portion 332B of the second optical sensor 332 to emit the light and whether or not the state of the light-receiving portion 330C of the first optical sensor 330 is the OFF state and the state of the light-receiving portion 332C of the second optical sensor 332 is the OFF state is determined in S27. When the control unit 400 determines that the state of the light-receiving portion 330C of the first optical sensor 330 is the OFF state and the state of the light-receiving portion 332C of the second optical sensor 332 is the OFF state, the control unit 400 repeats S27 periodically.

When the control unit 400 determines that the condition that the state of the light-receiving portion 330C of the first optical sensor 330 is the OFF state and the state of the light-receiving portion 332C of the second optical sensor 332 is the OFF state is not satisfied in S27, it means that the state of the light-receiving portion 330C of the first optical sensor 330 is the ON state and the state of the light-receiving portion 332C of the second optical sensor 332 is the OFF state. Then, the fact that the light-receiving portion 330C is in the ON state and the light-receiving portion 332C is in the OFF state means that the position of the ink surface L in the ink chamber 11 has reached the seventh ink surface position. Therefore, when the control unit 400 determines that the condition that the state of the light-receiving portion 330C of the first optical sensor 330 is the OFF state and the state of the light-receiving portion 332C of the second optical sensor 332 is the OFF state is not satisfied in S27, the control unit 400 determines that the remaining amount of ink in the ink chamber 11 is an amount which makes the position of the ink surface L to be equal to the seventh ink surface position, and causes the display portion 340 to display the remaining amount on the remaining amount display portion 340A of the display portion 340 in S28. More specifically, the remaining amount display portion 340A displays the remaining amount of ink as shown in FIG. 35(C). The control unit 400 also causes the display portion 340 to display the predetermined message to notify the user that the remaining amount of ink in the ink cartridge 10 is small. Thereafter, the control unit 400 causes the light-emitting portion 330B of the first optical sensor 330 and the light-emitting portion 332B of the second optical sensor 332 to stop emission of the light.

Then, the control unit 400 starts to count the number of times of ink discharge by the printhead 132 in S29. Then, in S30, whether or not the number of times of ink discharge by the printhead 132 exceeds the predetermined number of times is determined. When the control unit 400 determines that the number of times of ink discharge by the printhead 132 does not exceed the predetermined number of times, S30 is repeated periodically.

When it is determined that the number of times of ink discharge by the printhead 132 exceeds the predetermined number of times in S30, the control unit 400 causes the remaining amount display portion 340A of the display portion 340 to display a message saying the ink chamber 11 is empty in S31. More specifically, the remaining amount display portion 340A displays the remaining amount of ink as shown in FIG. 35(D). The control unit 400, for example, causes the display portion 340 to display the predetermined message to urge the user to replace the ink cartridge 10 with a new one, and ends the determination process shown in the flowcharts in FIG. 32 to FIG. 34.

When the control unit 400 determines that the state of the light-receiving portion 330C of the first optical sensor 330 is the ON state and the state of the light-receiving portion 332C of the second optical sensor 332 is the OFF state in S21, it means that the position of the ink surface L in the ink chamber 11 of the ink cartridge 10 mounted to the mounting portion 300 is lower than or equal to the seventh ink surface position. In this case, it may be considered that the ink chamber 11 is empty. Therefore, when the control unit 400 determines that the state of the light-receiving portion 3300 of the first optical sensor 330 is the ON state and the state of the light-receiving portion 332C of the second optical sensor 332 is the OFF state in S21, the control unit 400 causes the remaining amount display portion 340A of the display portion 340 to display the message saying that the ink chamber 11 is empty in S32. More specifically, the remaining amount display portion 340A displays the remaining amount of ink as shown in FIG. 35(D). The control unit 400, for example, causes the display portion 340 to display the predetermined message to urge the user to replace the ink cartridge 10 with a new one, and ends the determination process shown in the flowcharts in FIG. 32 to FIG. 34.

In S22, when the control unit 400 determines that the condition that the state of the light-receiving portion 330C of the first optical sensor 330 is the OFF state and the state of the light-receiving portion 332C of the second optical sensor 332 is the ON state is not satisfied, the procedure goes to S25.

In S25, when the control unit 400 determines that the condition that the state of the light-receiving portion 330C of the first optical sensor 330 is the OFF state and the state of the light-receiving portion 332C of the second optical sensor 332 is the OFF state is not satisfied, the procedure goes to S28.

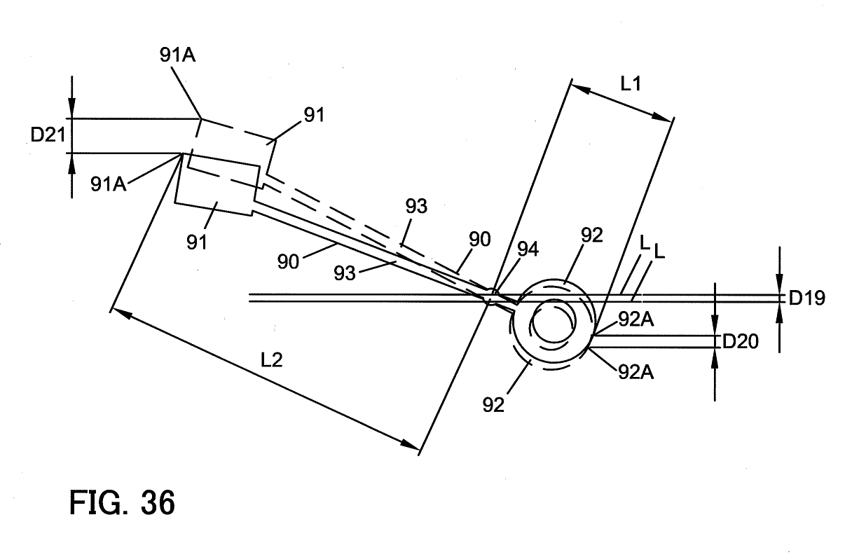

FIG. 36 shows the pivoting member 90 and the ink surface L extracted from FIG. 29 and FIG. 31 and superimposed one on top of another. For the sake of convenience, hatching is omitted, and the pivoting member 90 extracted from FIG. 31 is shown by the broken line in FIG. 36.

As shown in FIG. 36, the first distance L1 between the center of pivotal movement and the first end 92A is less than the second distance L2 between the center of pivotal movement and the second end 91A. Therefore, when a distance D20 the first end 92A moves in the vertical direction and a distance D21 the second end 91A moves in the vertical direction when the ink surface L moves from the fifth ink surface position to the seventh ink surface position are compared, the distance D20 of the first end 92A is almost the same as a distance D19 between the fifth ink surface position and the seventh ink surface position, while the distance D21 of the second end 91A is greater than the distance D19 between the fifth ink surface position and the seventh ink surface position. Therefore, even when the ink discharging system 1 is made to detect the fifth ink surface position and the seventh ink surface position, the first optical sensor 330 and the second optical sensor 332 can be positioned farther than the distance between the ink surface positions in the vertical direction. As in this embodiment, in a case where the initial amount of the ink stored in the ink chamber 11 is small, and the distance the ink surface moves is small, it is advantageous that the first optical sensor 330 and the second optical sensor 332 can be positioned farther than the distance the ink surface moves in the vertical direction.

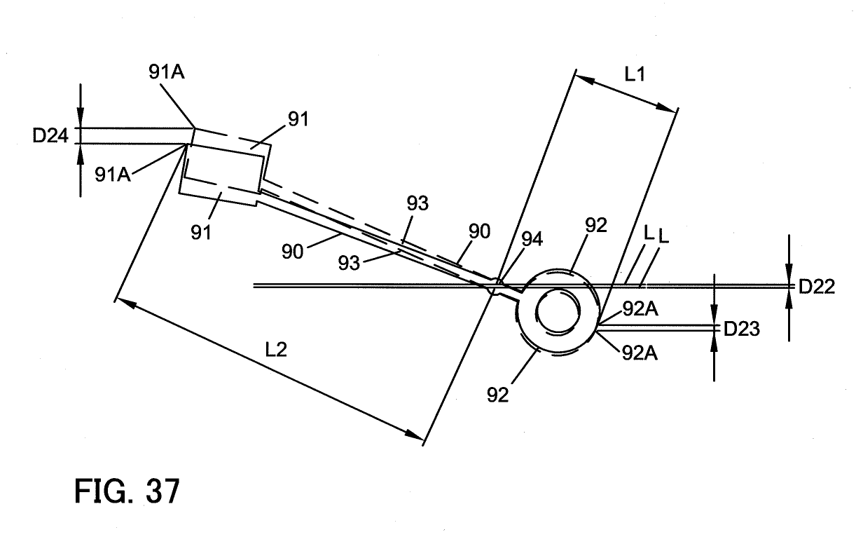

FIG. 37 shows the pivoting member 90 and the ink surface L extracted from FIG. 29 and FIG. 30 and superimposed one on top of another. For the sake of convenience, hatching is omitted, and the pivoting member 90 extracted from FIG. 30 is shown by the broken line in FIG. 37.

The first distance L1 between the center of pivotal movement and the first end 92A is less than the second distance L2 between the center of pivotal movement and the second end 91A. Therefore, as shown in FIG. 37, when a distance D23 the first end 92A moves in the vertical direction and a distance D24 the second end 91A moves in the vertical direction when the ink surface L moves from the fifth ink surface position to the sixth ink surface position are compared, the distance D23 of the first end 92A is almost the same as a distance D22 between the fifth ink surface position and the sixth ink surface position, while the distance D24 of the second end 91A is greater than the distance D22 between the fifth ink surface position and the sixth ink surface position. Therefore, even when the ink discharging system 1 is made to detect the fifth ink surface position and the sixth ink surface position, the first optical sensor 330 and the second optical sensor 332 can be positioned farther from each other than the distance between the ink surface positions in the vertical direction. As in this embodiment, in a case where the initial amount of the ink stored in the ink chamber 11 is small, and the distance the ink surface moves is small, it is advantageous that the first optical sensor 330 and the second optical sensor 332 can be positioned farther than the distance the ink surface moves in the vertical direction.

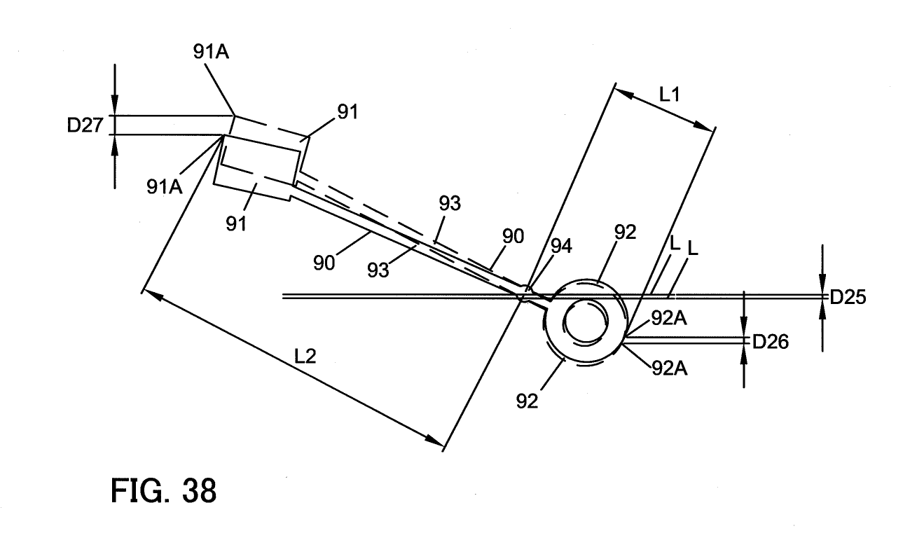

FIG. 38 shows the pivoting member 90 and the ink surface L extracted from FIG. 30 and FIG. 31 and superimposed one on top of another. For the sake of convenience, hatching is omitted, and the pivoting member 90 extracted from FIG. 31 is shown by the broken line in FIG. 38.

The first distance L1 between the center of pivotal movement and the first end 92A is less than the second distance L2 between the center of pivotal movement and the second end 91A. Therefore, as shown in FIG. 38, when a distance D26 the first end 92A moves in the vertical direction and a distance D27 the second end 91A moves in the vertical direction when the ink surface L moves from the sixth ink surface position to the seventh ink surface position are compared, the distance D26 of the first end 92A is almost the same as a distance D25 between the sixth ink surface position and the seventh ink surface position, while the distance D27 of the second end 91A is greater than the distance D25 between the sixth ink surface position and the seventh ink surface position. Therefore, even when the ink discharging system 1 is made to detect the sixth ink surface position and the seventh ink surface position, the first optical sensor 330 and the second optical sensor 332 can be positioned farther from each other than the distance between the ink surface positions in the vertical direction. As in this embodiment, in a case where the initial amount of the ink stored in the ink chamber 11 is small, and the distance the ink surface moves is small, it is advantageous that the first optical sensor 330 and the second optical sensor 332 can be positioned farther than the distance the ink surface moves in the vertical direction.

As a modification, for example, in a case where the ink cartridge 10 has the flat ink chamber 11 having the dimension in the widthwise direction 12 and the dimension in the depthwise direction 13 each longer than the dimension in the heightwise direction 14, the distance the ink surface moves is small. In such a case as well, it is advantageous that the first optical sensor 330 and the second optical sensor 332 can be positioned farther than the distance the ink surface moves in the vertical direction.

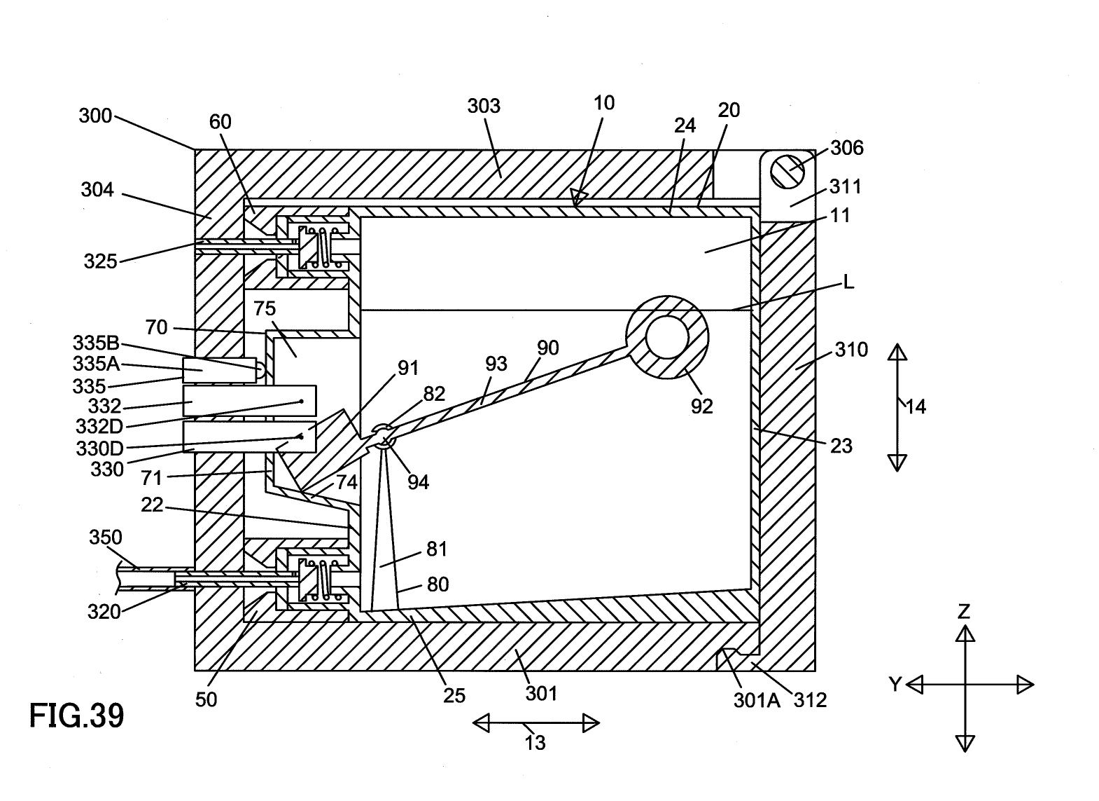

Referring to FIG. 39 to FIG. 41, the ink discharging system 1 according to a third embodiment of the present invention is described. Because the third embodiment is different from the first embodiment only in shape and arrangement of elements of the ink cartridge 10 and the mounting portion 300, the same reference numerals as the first embodiment are used for description of the third embodiment. Descriptions of the same elements as those in the first embodiment are omitted. Only elements which are different from those in the first embodiment are described.

When the ink surface L is higher than the eighth ink surface position, the detected portion 91 is in contact with the bottom wall 74 and intersects the optical path 330D of the first optical sensor 330, but does not intersect the optical path 332D of the second optical sensor 332. Also, the floating portion 92 is positioned higher than the first optical sensor 330, the second optical sensor 332, and the supporting portion 82.

When ink is supplied from the ink chamber 11 to the sub tank 135, and the ink surface L in the ink chamber 11 reaches the eighth ink surface position, a portion of the floating portion 92 is exposed in the air in the ink chamber 11 from the ink surface L as shown in FIG. 39, and the gravity and the buoyancy acting on the floating portion 92 becomes equal. The eighth ink surface position is higher than the first optical sensor 330, the second optical sensor 332, and the supporting portion 82. Also, when the ink surface L is at the eighth ink surface position, the floating portion 92 is positioned higher than the first optical sensor 330, the second optical sensor 332, and the supporting portion 82.

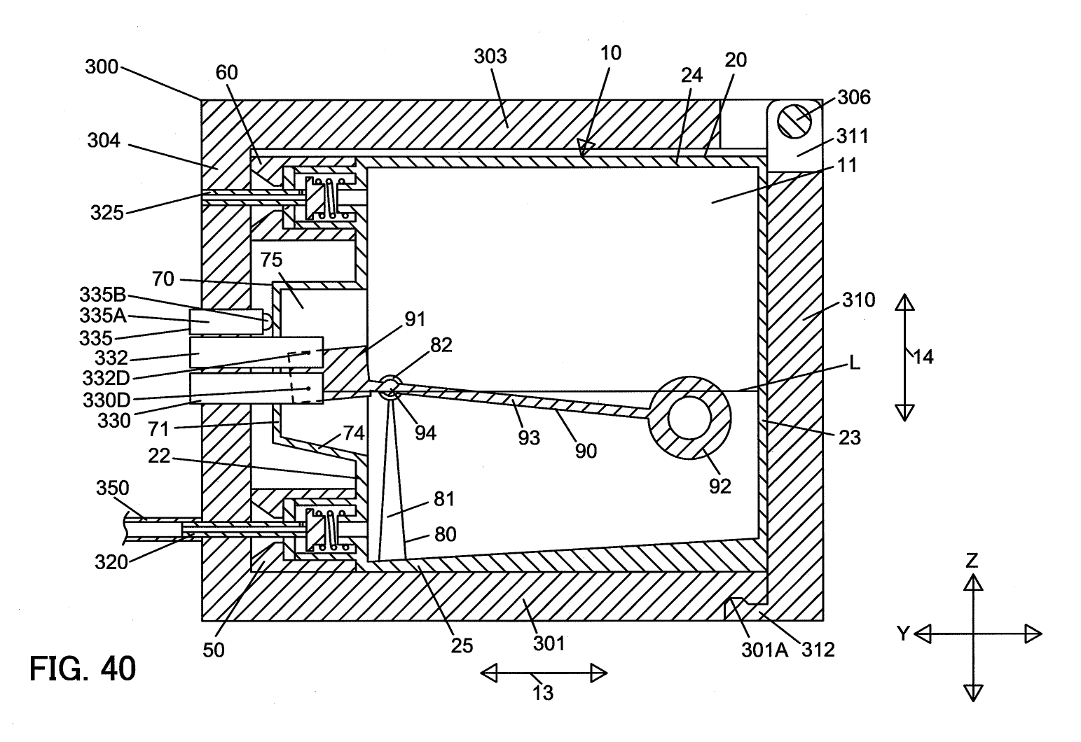

When ink is further supplied from the ink chamber 11 to the sub tank 135, the pivoting member 90 moves clockwise in FIG. 39 in association with the lowering of the ink surface L of the ink. As shown in FIG. 40, when the ink surface L reaches the ninth ink surface position, the detected portion 91 intersects the optical path 330D of the first optical sensor 330, and also intersects the optical path 332D of the second optical sensor 332. The ninth ink surface position is at substantially the same height as the first optical sensor 330, the second optical sensor 332, and the supporting portion 82. Also, when the ink surface L is at the ninth ink surface position, the floating portion 92 is positioned at substantially the same height as the first optical sensor 330, the second optical sensor 332, and the supporting portion 82.

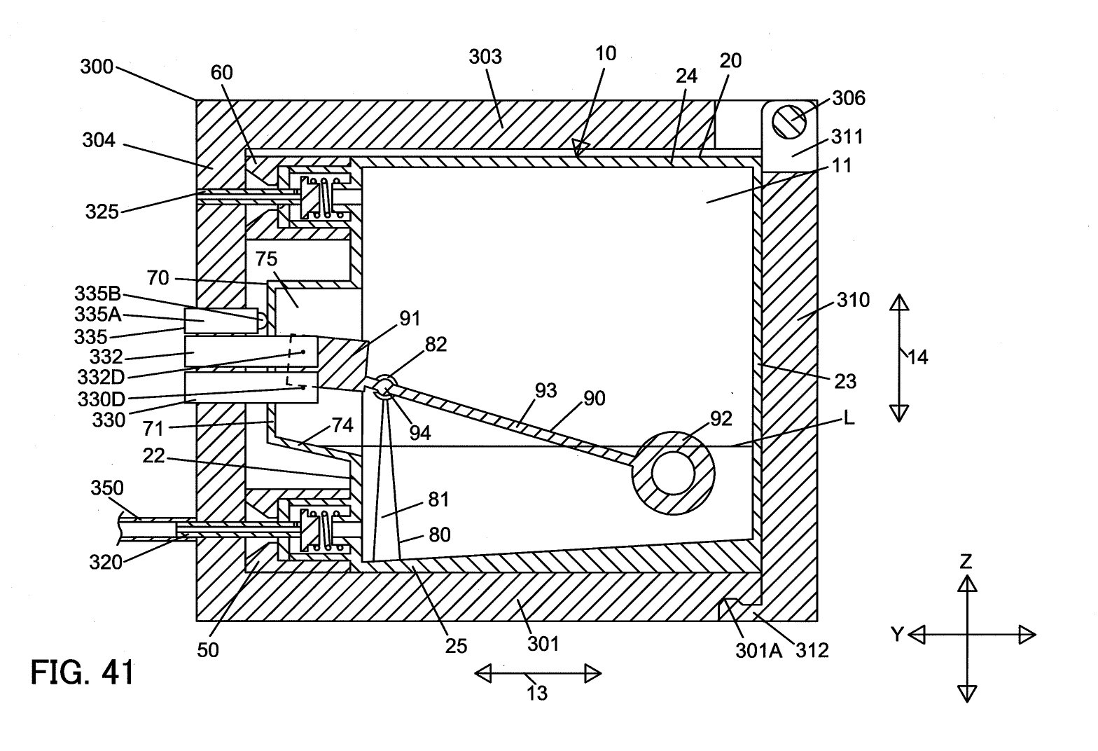

When ink is further supplied from the ink chamber 11 to the sub tank 135, the pivoting member 90 moves clockwise in FIG. 40 in association with the lowering of the ink surface L. As shown in FIG. 41, when the ink surface L reaches the tenth ink surface position, the detected portion 91 does not intersects the optical path 330D of the first optical sensor 330, but intersects the optical path 332D of the second optical sensor 332. The tenth ink surface position is lower than the first optical sensor 330, the second optical sensor 332, and the supporting portion 82. Also, when the ink surface L is at the tenth ink surface position, the floating portion 92 is positioned lower than the first optical sensor 330, the second optical sensor 332, and the supporting portion 82.

The flowcharts showing the steps of the process for determining the remaining amount of ink in the ink chamber 11 of the ink cartridge 10 performed by the control unit 400 according to the third embodiment are the same as the flowcharts showing the steps of the process for determining the amount of ink in the ink chamber 11 of the ink cartridge 10 performed by the control unit 400 according to the second embodiment.

In the embodiments shown above, the ink tank is the ink cartridge 10 are removable demountable from the ink-jet printer 100. However, the ink tank may be fixed to the ink-jet printer 100.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. An ink surface detecting system comprising:
an ink cartridge comprising:
an ink chamber configured to store ink therein; and
a pivoting member positioned in the ink chamber and configured to pivot in the ink chamber according to a position of a surface of the ink stored in the ink chamber, wherein the pivoting member comprises:
a detected portion; and
a floating portion having a specific gravity less than a specific gravity of the ink stored in the ink chamber;
a mounting portion to which the ink cartridge is configured to be removably mounted;
a first optical detector positioned at the mounting portion, comprising:
a first light-emitting portion configured to emit light in a direction intersecting a path along which the detected portion moves with respect to the ink chamber when the ink cartridge is mounted to the mounting portion; and
a first light-receiving portion configured to selectively assume two states according to a position of the detected portion in the path; and
a second optical detector positioned at the mounting portion above the first optical detector, comprising:
a second light-emitting portion configured to emit light in the direction intersecting the path when the ink cartridge is mounted to the mounting portion; and
a second light-receiving portion configured to selectively assume two states according to the position of the detected portion in the path,
wherein the pivoting member is configured to pivot with respect to the ink chamber in a first plane,
the floating portion and the detected portion are positioned such that a second plane is positioned between the floating portion and the detected portion when the ink cartridge is mounted to the mounting portion, the second plane being perpendicular to the first plane, intersecting a center of a pivotal movement of the pivoting member, and being parallel to the direction of gravity,
the floating portion comprises a first end positioned farthest from the center of the pivotal movement in the floating portion,
the detected portion comprises a second end positioned farthest from the center of the pivotal movement in the detected portion, and
wherein a first distance between the center of pivotal movement and the first end is different from a second distance between the center of pivotal movement and the second end.

2. The ink surface detecting system according to claim 1, wherein the first distance is greater than the second distance.

3. The ink surface detecting system according to claim 1, wherein the first distance is less than the second distance.

4. The ink surface detecting system according to claim 1,
wherein the mounting portion is configured such that the ink cartridge is mounted to the mounting portion by being inserted into the mounting portion along an insertion direction parallel to a horizontal direction,
the mounting portion comprises a first valve opening member and a second valve opening member,
the first optical detector, the second optical detector, the first valve opening member, and the second valve opening member are aligned in the direction of gravity at an end portion of the mounting portion with respect to the insertion direction,
the first valve opening member is positioned below the first optical detector and the second optical detector,
the second valve opening member is positioned above the first optical detector and the second optical detector,
the ink cartridge comprises a wall configured to face the end portion of the mounting portion when the ink cartridge is mounted to the mounting portion, a first valve mechanism positioned at the wall, and a second valve mechanism positioned at the wall,
the detected portion is positioned adjacent to the wall,
the first valve opening member is configured to open the first valve mechanism such that the ink is supplied from an interior of the ink chamber to an exterior of the ink chamber via the first valve mechanism when the ink cartridge is mounted to the mounting portion, and
wherein the second valve opening member is configured to open the second valve mechanism such that air is introduced from the exterior of the ink chamber to the interior of the ink chamber via the second valve mechanism when the ink cartridge is mounted to the mounting portion.

5. The ink surface detecting system according to claim 1,
wherein the first light-emitting portion and the first light-receiving portion are aligned in a horizontal direction,
the second light-emitting portion and the second light-receiving portion are aligned in the horizontal direction,
the pivoting member is configured to move between a first position and a second position, and between the second position and a third position with respect to the ink chamber according to the position of the surface of the ink stored in the ink chamber,
the detected portion is configured to intersect a first optical path formed between the first light-emitting portion and the first light-receiving portion and not to intersect a second optical path formed between the second light-emitting portion and the second light-receiving portion when the ink cartridge is mounted to the mounting portion and the pivoting member is in the first position,
the detected portion is configured to intersect both of the first optical path and the second optical path when the ink cartridge is mounted to the mounting portion and the pivoting member is in the second position, and
the detected portion is configured not to intersect the first optical path and to intersect the second optical path when the ink cartridge is mounted to the mounting portion and the pivoting member is in the third position.

6. The ink surface detecting system according to claim 5,
wherein the pivotal member is configured to move between the third position and a fourth position with respect to the ink chamber according to the position of the surface of the ink stored in the ink chamber, and
the detected portion is configured not to intersect the first optical path and not to intersect the second optical path when the ink cartridge is mounted to the mounting portion and the pivoting member is in the fourth position.

7. The ink surface detecting system according to claim 5,
wherein the floating portion is configured to be positioned higher than the first optical detector and the second optical detector when the ink cartridge is mounted to the mounting portion and the pivoting member is in the first position, and
the floating portion is configured to positioned lower than the first optical detector and the second optical detector when the ink cartridge is mounted to the mounting portion and the pivoting member is in the third position.

8. The ink surface detecting system according to claim 6,
wherein the floating portion is configured to be positioned higher than the first optical detector and the second optical detector when the ink cartridge is mounted to the mounting portion and the pivoting member is in the first position, and
the floating portion is configured to be positioned lower than the first optical detector and the second optical detector when the ink cartridge is mounted to the mounting portion and the pivoting member is in the fourth position.

9. An ink surface detecting system comprising:
an ink tank comprising:
an ink chamber configured to store ink therein; and
a pivoting member positioned in the ink chamber and configured to pivot in the ink chamber according to a position of a surface of the ink stored in the ink chamber, wherein the pivoting member comprises:
a detected portion; and
a floating portion having a specific gravity less than a specific gravity of the ink stored in the ink chamber;
a first optical detector comprising:
a first light-emitting portion configured to emit light in a direction intersecting a path along which the detected portion moves with respect to the ink chamber; and
a first light-receiving portion configured to selectively assume two states according to a position of the detected portion in the path; and
a second optical detector positioned above the first optical detector, comprising:
a second light-emitting portion configured to emit light in the direction intersecting the path; and
a second light-receiving portion configured to selectively assume two states according to the position of the detected portion in the path,
wherein the pivoting member is configured to pivot with respect to the ink chamber in a first plane,
the floating portion and the detected portion are positioned such that a second plane is positioned between the floating portion and the detected portion when the ink cartridge is mounted to the mounting portion, the second plane being perpendicular to the first plane, intersecting a center of a pivotal movement of the pivoting member, and being parallel to the direction of gravity,
the floating portion comprises a first end positioned farthest from the center of the pivotal movement in the floating portion,
the detected portion comprises a second end positioned farthest from the center of the pivotal movement in the detected portion, and
wherein a first distance between the center of pivotal movement and the first end is different from a second distance between the center of pivotal movement and the second end.

10. The ink surface detecting system according to claim 9, wherein the first distance is greater than the second distance.

11. The ink surface detecting system according to claim 9, wherein the first distance is less than the second distance.

12. The ink surface detecting system according to claim 9,
wherein the first light-emitting portion and the first light-receiving portion are aligned in a horizontal direction,
the second light-emitting portion and the second light-receiving portion are aligned in the horizontal direction,
the pivoting member is configured to move between a first position and a second position, and between the second position and a third position with respect to the ink chamber according to the position of the surface of the ink stored in the ink chamber,
the detected portion is configured to intersect a first optical path formed between the first light-emitting portion and the first light-receiving portion and not to intersect a second optical path formed between the second light-emitting portion and the second light-receiving portion when the pivoting member is in the first position,
the detected portion is configured to intersect both of the first optical path and the second optical path when the pivoting member is in the second position, and
the detected portion is configured not to intersect the first optical path and to intersect the second optical path when the pivoting member is in the third position.

13. The ink surface detecting system according to claim 12,
wherein the pivotal member is configured to move between the third position and a fourth position with respect to the ink chamber according to the position of the surface of the ink stored in the ink chamber, and
the detected portion is configured not to intersect the first optical path and not to intersect the second optical path when the pivoting member is in the fourth position.

14. The ink surface detecting system according to claim 12,
wherein the floating portion is configured to be positioned higher than the first optical detector and the second optical detector when the pivoting member is in the first position, and
the floating portion is configured to positioned lower than the first optical detector and the second optical detector when the pivoting member is in the third position.

15. The ink surface detecting system according to claim 13,
wherein the floating portion is configured to be positioned higher than the first optical detector and the second optical detector when the pivoting member is in the first position, and
the floating portion is configured to be positioned lower than the first optical detector and the second optical detector when the pivoting member is in the fourth position.

16. An ink cartridge comprising:
an ink chamber configured to store ink therein; and
a pivoting member positioned in the ink chamber and configured to pivot in the ink chamber according to a position of a surface of the ink stored in the ink chamber, wherein the pivoting member comprises:
a detected portion; and
a floating portion having a specific gravity less than a specific gravity of the ink stored in the ink chamber;
wherein the pivoting member is configured to pivot with respect to the ink chamber in a first plane,
the floating portion and the detected portion are positioned such that a second plane is positioned between the floating portion and the detected portion, the second plane being perpendicular to the first plane, intersecting a center of a pivotal movement of the pivoting member,
the floating portion comprises a first end positioned farthest from the center of the pivotal movement in the floating portion,
the detected portion comprises a second end positioned farthest from the center of the pivotal movement in the detected portion, and
wherein a first distance between the center of pivotal movement and the first end is greater than a second distance between the center of pivotal movement and the second end.
